(19) United States
(12) Patent Application Publication
(10) Pub. No.: US 2018/0109406 A1
(43) Pub. Date: Apr. 19, 2018

(54) RESOURCE BLOCK ALIGNMENT IN MIXED NUMEROLOGY WIRELESS COMMUNICATIONS

(71) Applicant: QUALCOMM Incorporated, San Diego, CA (US)

(72) Inventors: Renqiu Wang, San Diego, CA (US); Hao Xu, Beijing (CN); Peter Pui Lok Ang, San Diego, CA (US); Jing Jiang, San Diego, CA (US); Tingfang Ji, San Diego, CA (US)

(21) Appl. No.: 15/786,541

(22) Filed: Oct. 17, 2017

Related U.S. Application Data
(60) Provisional application No. 62/410,371, filed on Oct. 19, 2016.

(51) Int. Cl. H04L 27/26; H04W 72/04; H04L 5/00

(52) U.S. Cl. CPC H04L 27/2605; H04W 72/0446; H04L 5/0053; H04L 5/0007; H04L 5/0076; H04L 5/0044

(57) ABSTRACT

Techniques are described that provide for resource block (RB) alignment in mixed numerology wireless communications, in which a number of RBs for a particular numerology may occupy less than an entire system bandwidth. A fractional bandwidth may be identified as a difference between the bandwidth of the integer number of RBs and the system bandwidth and may be used to transmit information using one or more fractional RBs that may have a same or different numerology as the integer number of RBs. In some examples a placement scheme may be selected for placing the integer number of RBs, one or more fractional RBs, and/or one or more guard bands, within the system bandwidth. Numbering schemes for transmitted RBs and placement schemes may be signaled or may be implicitly determined based on one or more numerologies of the transmitted RBs or transmitted fractional RBs.

### CROSS REFERENCES

The present Application for Patent claims priority to U.S. Provisional Patent Application No. 62/410,371 by Wang et al., entitled “Resource Block Alignment In Mixed Numerology Wireless Communications,” filed Oct. 19, 2016, assigned to the assignee hereof.

### INTRODUCTION

The following relates generally to wireless communication, and more specifically to resource block alignment in mixed numerology wireless communications.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

In some examples, a wireless multiple-access communication system may include a number of base stations, each simultaneously supporting communication for multiple communication devices, otherwise known as user equipment (UE). In a Long-Term Evolution (LTE) or LTE-Advanced (LTE-A) network, a set of one or more base stations may define an eNodeB (eNB). In other examples (e.g., in a next generation new radio (NR) or 5th Generation (5G) network), a wireless multiple access communication system may include a number of smart radio heads (RHs) in communication with a number of access node controllers (ANCs), where a set of one or more RHs, in communication with an ANC, defines a base station (e.g., an eNB). A base station may communicate with a set of UEs on downlink (DL) channels (e.g., for transmissions from a base station to a UE) and uplink (UL) channels (e.g., for transmissions from a UE to a base station).

As communication providers continue to increase the capacity of wireless networks, and as demand for such capacity grows, efficient use of wireless resources becomes increasingly relevant for high quality and relatively low cost wireless communications. One technique used to enhance the efficiency of wireless networks is providing various different services that may have different throughput and latency requirements. Such different services may have different transmission numerologies, including different tone spacing and different cyclic prefixes, based on the particular type of data to be transmitted using the different services. Efficient use of network resources in the presence of such mixed numerology services may help to enhance overall network efficiency and enhance data throughput using network resources.

### SUMMARY

A method of wireless communication is described. The method may include identifying an integer number of resource blocks (RBs) for transmission using a system bandwidth, wherein the integer number of RBs occupy less bandwidth than the system bandwidth, identifying a fractional bandwidth as a difference between a bandwidth occupied by the integer number of RBs and the system bandwidth, identifying one or more fractional RBs within at least a portion of the fractional bandwidth, selecting a placement scheme for placing the integer number of RBs and the one or more fractional RBs within the system bandwidth, and transmitting information over the integer number of RBs to a receiver using the placement scheme.

An apparatus for wireless communication is described. The apparatus may include means for identifying an integer number of RBs for transmission using a system bandwidth, wherein the integer number of RBs occupy less bandwidth than the system bandwidth, means for identifying a fractional bandwidth as a difference between a bandwidth occupied by the integer number of RBs and the system bandwidth, means for identifying one or more fractional RBs within at least a portion of the fractional bandwidth, means for selecting a placement scheme for placing the integer number of RBs and the one or more fractional RBs within the system bandwidth, and means for transmitting information over the integer number of RBs to a receiver using the placement scheme.

Another apparatus for wireless communication is described. The apparatus may include a processor, memory in electronic communication with the processor, and instructions stored in the memory. The instructions may be operable to cause the processor to identify an integer number of RBs for transmission using a system bandwidth, wherein the integer number of RBs occupy less bandwidth than the system bandwidth, identify a fractional bandwidth as a difference between a bandwidth occupied by the integer number of RBs and the system bandwidth, identify one or more fractional RBs within at least a portion of the fractional bandwidth, select a placement scheme for placing the integer number of RBs and the one or more fractional RBs within the system bandwidth, and transmit information over the integer number of RBs to a receiver using the placement scheme.

A non-transitory computer readable medium for wireless communication is described. The non-transitory computer-readable medium may include instructions operable to cause a processor to identify an integer number of RBs for transmission using a system bandwidth, wherein the integer number of RBs occupy less bandwidth than the system bandwidth, identify a fractional bandwidth as a difference between a bandwidth occupied by the integer number of RBs and the system bandwidth, identify one or more fractional RBs within at least a portion of the fractional bandwidth, select a placement scheme for placing the integer number of RBs and the one or more fractional RBs within the system bandwidth, and transmit information over the integer number of RBs to a receiver using the placement scheme.

In some examples of the method, apparatus, and non-transitory computer-readable medium described above, the integer number of RBs may be associated with a first wireless service that uses a different numerology than a second wireless service.

In some examples of the method, apparatus, and non-transitory computer-readable medium described above, the selecting the placement scheme comprises one or more of selecting a one-edge placement scheme in which at least a portion of the fractional bandwidth may be placed at one edge of the system bandwidth, selecting a two-edge placement scheme in which a first portion of the fractional bandwidth may be placed at a first edge of the system bandwidth and a second portion of the fractional bandwidth may be placed at a second edge of the system bandwidth, or selecting a mid-bandwidth placement scheme in which at least a portion of the fractional bandwidth may be placed between two RBs of the integer number of RBs within the system bandwidth. In some examples of the method, apparatus, and non-transitory computer-readable medium described above, the first portion of the fractional bandwidth and the second portion of the fractional bandwidth may be symmetric or asymmetric.

In some examples of the method, apparatus, and non-transitory computer-readable medium described above, the placement scheme may be identified based at least in part on the system bandwidth and a tone spacing associated with the integer number of RBs. In some examples of the method, apparatus, and non-transitory computer-readable medium described above, the placement scheme comprises a location for one or more portions of the fractional bandwidth within the system bandwidth and an RB numbering scheme for the integer number of RBs and the one or more fractional RBs. In some examples of the method, apparatus, and non-transitory computer-readable medium described above, the placement scheme may be implicitly determined based at least in part on the system bandwidth and a tone spacing for the integer number of RBs.

Some examples of the method, apparatus, and non-transitory computer-readable medium described above may further include processes, features, means, or instructions for transmitting signaling to indicate the placement scheme. In some examples of the method, apparatus, and non-transitory computer-readable medium described above, the signaling may be transmitted in a system information block (SIB) to the receiver. In some examples of the method, apparatus, and non-transitory computer-readable medium described above, the signaling comprises one or more bits that may be mapped to a predetermined placement scheme.

In some examples of the method, apparatus, and non-transitory computer-readable medium described above, the one or more fractional RBs may have a same numerology as the integer number of RBs. In some examples of the method, apparatus, and non-transitory computer-readable medium described above, the one or more fractional RBs may have a sub-allocation of fewer tones than a number of tones of each of the integer number of RBs. In some examples of the method, apparatus, and non-transitory computer-readable medium described above, the integer number of RBs may have a first numerology and the one or more fractional RBs may have a second numerology that may be different than the first numerology. In some examples of the method, apparatus, and non-transitory computer-readable medium described above, the one or more fractional RBs comprise a second integer number of RBs for the second numerology.

In some examples of the method, apparatus, and non-transitory computer-readable medium described above, the one or more fractional RBs occupy a first portion of the fractional bandwidth and wherein a second portion of the fractional bandwidth may be placed as a guard band between the integer number of RBs and the one or more fractional RBs.

A method of wireless communication is described. The method may include identifying an integer number of RBs for a received transmission over a system bandwidth, wherein the integer number of RBs occupy less bandwidth than the system bandwidth, identifying a fractional bandwidth of the received transmission based at least in part of a difference between a bandwidth occupied by the integer number of RBs and the system bandwidth, identifying one or more fractional RBs within at least a portion of the fractional bandwidth, identifying a placement scheme for the fractional RBs and the integer number of RBs within the system bandwidth, and demodulating and decoding the integer number of RBs based at least in part on the placement scheme.

An apparatus for wireless communication is described. The apparatus may include means for identifying an integer number of RBs for a received transmission over a system bandwidth, wherein the integer number of RBs occupy less bandwidth than the system bandwidth, means for identifying a fractional bandwidth of the received transmission based at least in part of a difference between a bandwidth occupied by the integer number of RBs and the system bandwidth, means for identifying one or more fractional RBs within at least a portion of the fractional bandwidth, means for identifying a placement scheme for the fractional RBs and the integer number of RBs within the system bandwidth, and means for demodulating and decoding the integer number of RBs based at least in part on the placement scheme.

Another apparatus for wireless communication is described. The apparatus may include a processor, memory in electronic communication with the processor, and instructions stored in the memory. The instructions may be operable to cause the processor to identify an integer number of RBs for a received transmission over a system bandwidth, wherein the integer number of RBs occupy less bandwidth than the system bandwidth, identify a fractional bandwidth of the received transmission based at least in part of a difference between a bandwidth occupied by the integer number of RBs and the system bandwidth, identify one or more fractional RBs within at least a portion of the fractional bandwidth, identify a placement scheme for the fractional RBs and the integer number of RBs within the system bandwidth, and demodulate and decode the integer number of RBs based at least in part on the placement scheme.

A non-transitory computer readable medium for wireless communication is described. The non-transitory computer-readable medium may include instructions operable to cause a processor to identify an integer number of RBs for a received transmission over a system bandwidth, wherein the integer number of RBs occupy less bandwidth than the system bandwidth, identify a fractional bandwidth of the received transmission based at least in part of a difference between a bandwidth occupied by the integer number of RBs and the system bandwidth, identify one or more fractional RBs within at least a portion of the fractional bandwidth, identify a placement scheme for the fractional RBs and the integer number of RBs within the system bandwidth, and demodulate and decode the integer number of RBs based at least in part on the placement scheme.

In some examples of the method, apparatus, and non-transitory computer-readable medium described above, the integer number of RBs may be associated with a first wireless service that uses a different numerology than a second wireless service.

In some examples of the method, apparatus, and non-transitory computer-readable medium described above, the identifying the placement scheme comprises one or more of identifying a one-edge placement scheme in which at least a portion of the fractional bandwidth may be placed at one edge of the system bandwidth, identifying a two-edge placement scheme in which a first portion of the fractional bandwidth may be placed at a first edge of the system bandwidth and a second portion of the fractional bandwidth may be placed at a second edge of the system bandwidth, or identifying a mid-bandwidth placement scheme in which at least a portion of the fractional bandwidth may be placed between two RBs of the integer number of RBs within the system bandwidth. In some examples of the method, apparatus, and non-transitory computer-readable medium described above, the first portion of the fractional bandwidth and the second portion of the fractional bandwidth may be symmetric or asymmetric.

In some examples of the method, apparatus, and non-transitory computer-readable medium described above, the placement scheme comprises a location for one or more portions of the fractional bandwidth within the system bandwidth and an RB numbering scheme for the integer number of RBs and the one or more fractional RBs transmitted within the fractional bandwidth. In some examples of the method, apparatus, and non-transitory computer-readable medium described above, the placement scheme may be determined implicitly based at least in part on the system bandwidth and a tone spacing of the integer number of RBs. Some examples of the method, apparatus, and non-transitory computer-readable medium described above may further include processes, features, means, or instructions for receiving signaling to indicate the placement scheme. In some examples of the method, apparatus, and non-transitory computer-readable medium described above, the signaling may be received in a system information block (SIB). In some examples of the method, apparatus, and non-transitory computer-readable medium described above, the signaling comprises one or more bits that may be mapped to a predetermined placement scheme.

In some examples of the method, apparatus, and non-transitory computer-readable medium described above, the one or more fractional RBs may have a same numerology as the integer number of RBs. In some examples of the method, apparatus, and non-transitory computer-readable medium described above, the integer number of RBs may have a first numerology and the one or more fractional RBs may have a second numerology that may be different than the first numerology. In some examples of the method, apparatus, and non-transitory computer-readable medium described above, the one or more fractional RBs comprise a second integer number of RBs for the second numerology. In some examples of the method, apparatus, and non-transitory computer-readable medium described above, the one or more fractional RBs occupy a first portion of the fractional bandwidth and wherein a second portion of the fractional bandwidth may be placed as a guard band between the integer number of RBs and the one or more fractional RBs.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communication system, in accordance with various aspects of the present disclosure;

FIG. 2 illustrates an example of a portion of a wireless communication system that supports resource block alignment in mixed numerology wireless transmissions in accordance with aspects of the present disclosure.

FIG. 3 illustrates an example of mixed numerology transmissions and fractional bandwidth placement schemes in accordance with aspects of the present disclosure.

FIG. 4 illustrates an example of resource block alignments in mixed numerology wireless transmissions in accordance with aspects of the present disclosure.

FIGS. 5A and 5B illustrate examples of resource block alignments in mixed numerology wireless transmissions in accordance with aspects of the present disclosure.

FIG. 6 illustrates further examples of resource block alignments in mixed numerology wireless transmissions in accordance with aspects of the present disclosure.

FIG. 7 illustrates an example of a process flow that supports resource block alignment in mixed numerology wireless transmissions in accordance with aspects of the present disclosure.

FIGS. 8 through 10 show block diagrams of a device that supports resource block alignment in mixed numerology wireless transmissions in accordance with aspects of the present disclosure.

FIG. 11 illustrates a block diagram of a system including a base station that supports resource block alignment in mixed numerology wireless transmissions in accordance with aspects of the present disclosure.

FIGS. 12 through 14 show block diagrams of a device that supports resource block alignment in mixed numerology wireless transmissions in accordance with aspects of the present disclosure.

FIG. 15 illustrates a block diagram of a system including a UE that supports resource block alignment in mixed numerology wireless transmissions in accordance with aspects of the present disclosure.

FIGS. 16 through 17 illustrate methods for resource block alignment in mixed numerology wireless transmissions in accordance with aspects of the present disclosure.

### DETAILED DESCRIPTION

Techniques are described that provide for resource block (RB) alignment in mixed numerology wireless communications, in which a non-integer number of RBs for a particular numerology may occupy a system bandwidth. In such cases, a fractional bandwidth may be identified as a difference between the bandwidth of the integer number of RBs and the system bandwidth. This fractional bandwidth may be used, in some examples, to transmit information using one or more fractional RBs that may have a same or different numerology as the integer number of RBs. Additionally or alternatively, all or a portion of the fractional bandwidth may be used to provide a guard band between RBs. In some examples a placement scheme may be selected for placing the integer number of RBs, one or more fractional RBs, and/or one or more guard bands, within the system bandwidth. Numbering schemes for transmitted RBs and placement schemes may be signaled or may be implicitly determined based on one or more numerologies of the transmitted RBs or transmitted fractional RBs.

As indicated above, in some cases different services may be selected for data communications depending upon the nature of the communications. For example, communications that require low latency and high reliability may be served through a lower-latency service (e.g., an ultra-reliable low-latency communication (URLLC) service), while communications that are more delay-tolerant may be served through a service that provides relatively higher throughput with somewhat higher latency such as a mobile broadband service (e.g., an enhanced mobile broadband (eMBB) service). In other examples, communications may be with one or more user equipment (UEs) that are incorporated into other devices (e.g., meters, vehicles, appliances, machinery, etc.), and a machine-type communication (MTC) service (e.g., massive MTC (mMTC)) may be used for such communications. In some cases, different services (e.g., eMBB, URLLC, mMTC) may have different sub-carrier (or tone) spacing (e.g., 15 kilohertz (kHz), 30 kHz, 60 kHz, 120 kHz, etc.) and different cyclic prefixes. Such different tone spacing may result in a system bandwidth that is not divisible by a bandwidth of an integer number of RBs. Techniques provided herein provide for efficient use of fractional bandwidth between a bandwidth occupied by the integer number of RBs and the total system bandwidth, and may thereby enhance the overall efficiency of a wireless network and provide efficient use of wireless resources available to such a wireless network.

The present disclosure describes various techniques with reference to next generation networks (e.g., 5th Generation (5G) or New Radio (NR) networks) that are being designed to support features such as high bandwidth operations, more dynamic subframe/slot types, and self-contained subframe/slot types (in which HARQ feedback for a subframe/slot may be transmitted before the end of the subframe/slot). However, such techniques may be used for any system in which different services that have different numerologies may be used for uplink and/or downlink communications.

Aspects of the disclosure are initially described in the context of a wireless communications system. Aspects of the disclosure are further illustrated by and described with reference to diagrams, system diagrams, and flowcharts that relate to RB alignment in mixed numerology wireless communications.

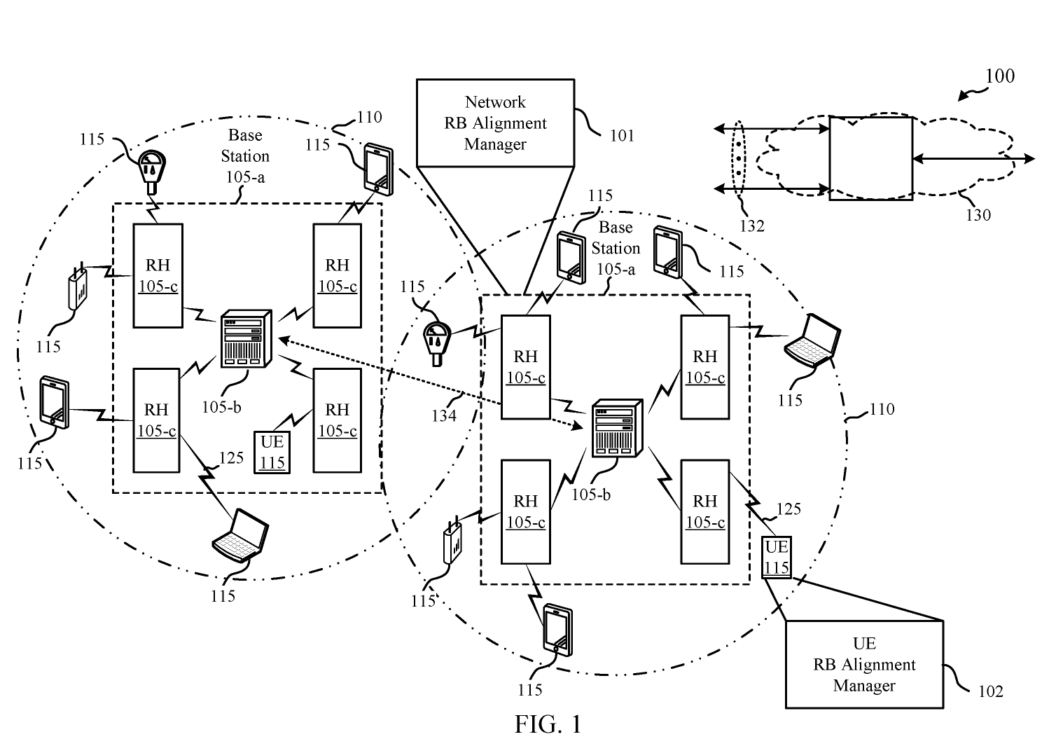

FIG. 1 illustrates an example of a wireless communication system 100, in accordance with various aspects of the disclosure. The wireless communication system 100 may include network devices 105, UEs 115, and a core network 130. Wireless communication system 100 may support different numerologies for synchronization signal transmissions and data channel transmissions. For example, wireless communication system 100 may support a first numerology for data channel transmissions of a first service (e.g., eMBB) in a downlink regular burst and may support a second numerology for a second service (e.g., URLLC) in the downlink regular burst or in a different downlink regular burst.

A core network 130 may provide user authentication, access authorization, tracking, Internet Protocol (IP) connectivity, and other access, routing, or mobility functions. At least some of the network devices 105 (e.g., network device 105-a, which may be an example of a LTE eNB, an eLTE eNB, an NR gNB, an NR Node-B, an NR access node or a base station, network device 105-b, which may be an example of an access node controller (ANC), or a centralized unit) may interface with the core network 130 through backhaul links 132 (e.g., S1, S2, NG-1, NG-2, NG-3, NG-C, NG-U etc.) and may perform radio configuration and scheduling for communication with the UEs 115 within an associated coverage area 110. In various examples, the network devices 105-b may communicate, either directly or indirectly (e.g., through core network 130), with each other over backhaul links 134 (e.g., X1, X2, Xn etc.), which may be wired or wireless communication links.

Each network device 105-b may also communicate with a number of UEs 115 through a number of other network devices 105-c, where network device 105-c may be an example of a transmission reception point (TRP), a distributed unit (DU), a radio head (RH), a remote radio head (RRH), or a smart radio head. In alternative configurations, various functions of each network device 105 may be distributed across various network devices 105 (e.g., radio heads/distributed units and access network controllers/centralized units) or consolidated into a single network device 105 (e.g., a base station/an access node).

The wireless communication system 100 may support synchronous or asynchronous operation. For synchronous operation, the network devices 105-a and/or network devices 105-c may have similar frame timing, and transmissions from different network devices 105-a and/or network devices 105-c may be approximately aligned in time. For asynchronous operation, the network devices 105-a and/or network devices 105-c may have different frame timings, and transmissions from different network devices 105-a and/or network devices 105-c may not be aligned in time. The techniques described herein may be used for either synchronous or asynchronous operations.

The UEs 115 may be dispersed throughout the wireless communication system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, a IoE device, a smart phone, a smart watch, a customer premises equipment (CPE) or the like. A UE 115 may be able to communicate with various types of network devices 105-a, network devices 105-c, base stations, access points, or other network devices, including macro eNBs, small cell eNBs, relay base stations, and the like. A UE may also be able to communicate directly with other UEs (e.g., using a peer-to-peer (P2P) protocol).

The communication links 125 shown in wireless communication system 100 may include uplink (UL) channels from a UE 115 to a network device 105, and/or DL channels, from a network device 105 to a UE 115. The downlink channels may also be called forward link channels, while the uplink channels may also be called reverse link channels. Control information and data may be multiplexed on an uplink channel or downlink according to various techniques. Control information and data may be multiplexed on a downlink channel, for example, using time division multiplexing (TDM) techniques, frequency division multiplexing (FDM) techniques, or hybrid TDM-FDM techniques. In some examples, the control information transmitted during a transmission time interval (TTI) of a downlink channel may be distributed between different control regions in a cascaded manner (e.g., between a common control region and one or more UE-specific control regions).

Wireless communication system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both frequency division duplexing (FDD) and time division duplexing (TDD) component carriers.

In some cases, wireless communication system 100 may utilize enhanced component carriers (eCCs). An eCC may be characterized by one or more features including: wider bandwidth, shorter symbol duration, and shorter TTIs. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (where more than one operator is allowed to use the spectrum). In some cases, an eCC may utilize a different symbol duration than other CCs, which may include use of a reduced symbol duration as compared with symbol durations of the other CCs. A shorter symbol duration is associated with increased subcarrier spacing. A device, such as a UE 115 or base station 105, utilizing eCCs may transmit wideband signals (e.g., 20 megahertz (MHz), 40 MHz, 60 MHz, 80 MHz, etc.) at reduced symbol durations (e.g., 16.67 microseconds). A TTI in eCC may consist of one or multiple symbols. In some cases, the TTI duration (that is, the number of symbols in a TTI) may be variable. A 5G or NR carrier may be considered an eCC.

Wireless communication system 100 may operate in an ultra high frequency (UHF) frequency region using frequency bands from 700 MHz to 2600 MHz (2.6 gigahertz (GHz)), although in some cases wireless local area network (WLAN) networks may use frequencies as high as 4 GHz. This region may also be known as the decimeter band, since the wavelengths range from approximately one decimeter to one meter in length. UHF waves may propagate mainly by line of sight, and may be blocked by buildings and environmental features. However, the waves may penetrate walls sufficiently to provide service to UEs 115 located indoors. Transmission of UHF waves is characterized by smaller antennas and shorter range (e.g., less than 100 km) compared to transmission using the smaller frequencies (and longer waves) of the high frequency (HF) or very high frequency (VHF) portion of the spectrum. In some cases, wireless communication system 100 may also utilize extremely high frequency (EHF) portions of the spectrum (e.g., from 30 GHz to 300 GHz). This region may also be known as the millimeter band, since the wavelengths range from approximately one millimeter to one centimeter in length, and systems that use this region may be referred to as millimeter wave (mmW) systems. Thus, EHF antennas may be even smaller and more closely spaced than UHF antennas. In some cases, this may facilitate use of antenna arrays within a UE 115 (e.g., for directional beamforming). Techniques disclosed herein may be employed across transmissions that use one or more different frequency regions.

Wireless communication system 100 may utilize OFDMA on the downlink (DL) and a single carrier waveform, such as discrete Fourier transform (DFT) spread OFDM (DFT-s-OFDM) or SC-FDMA, on the uplink (UL). OFDMA and DFT-s-OFDM partition the system bandwidth into multiple orthogonal subcarriers (K), which are also commonly referred to as tones or bins. Each subcarrier may be modulated with data. The spacing between adjacent subcarriers may be fixed, and the total number of subcarriers (K) may be dependent on the system bandwidth. For example, for some services, K may be equal to 72, 180, 300, 600, 900, or 1200 with a subcarrier spacing of 15 kHz for a corresponding system bandwidth (with guardband) of 1.4, 3, 5, 10, 15, or 20 MHz, respectively. Other services may have different sub-carrier spacing, also referred to as tone spacing, that may be a multiple of a base 15 kHz tone spacing. The system bandwidth may also be partitioned into sub-bands. For example, a sub-band may cover 1.08 MHz, and there may be 1, 2, 4, 8 or 16 sub-bands. A resource element (RE) may be one tone within one OFDM symbol, and an RB may include 12 REs.

As indicated above, wireless communication system 100 may be used for communicating information over a number of different services. Such services may include, for example, data services in which relatively large amounts of data are transmitted over communication links 125. Such data services may be used to transmit voice, video, or other data. In some cases, data services may include an eMBB service. Wireless communication system 100 may also provide URLLC services, which may provide low latency services with high reliability as may be desired in certain applications (e.g., remote control, wireless automation of production facilities, vehicular traffic efficiency and safety, mobile gaming, etc.). Wireless communication system 100 may also provide mMTC services, in which UEs 115 may be incorporated into other devices (e.g., meters, vehicles, appliances, machinery, etc.). Such services may have different and independent air interfaces and channel numerologies that may have, for example, different coding/modulation, different tone spacing, separate synchronization channels, different master information blocks (MIBs), different system information blocks (SIBs), etc. In some cases, a UE 115 or base station 105 may identify different services based on the air interface associated with the particular service. In cases where services have different tone spacing, RB size for such services may also be different, which may result in an integer number of RBs not occupying an entire system bandwidth.

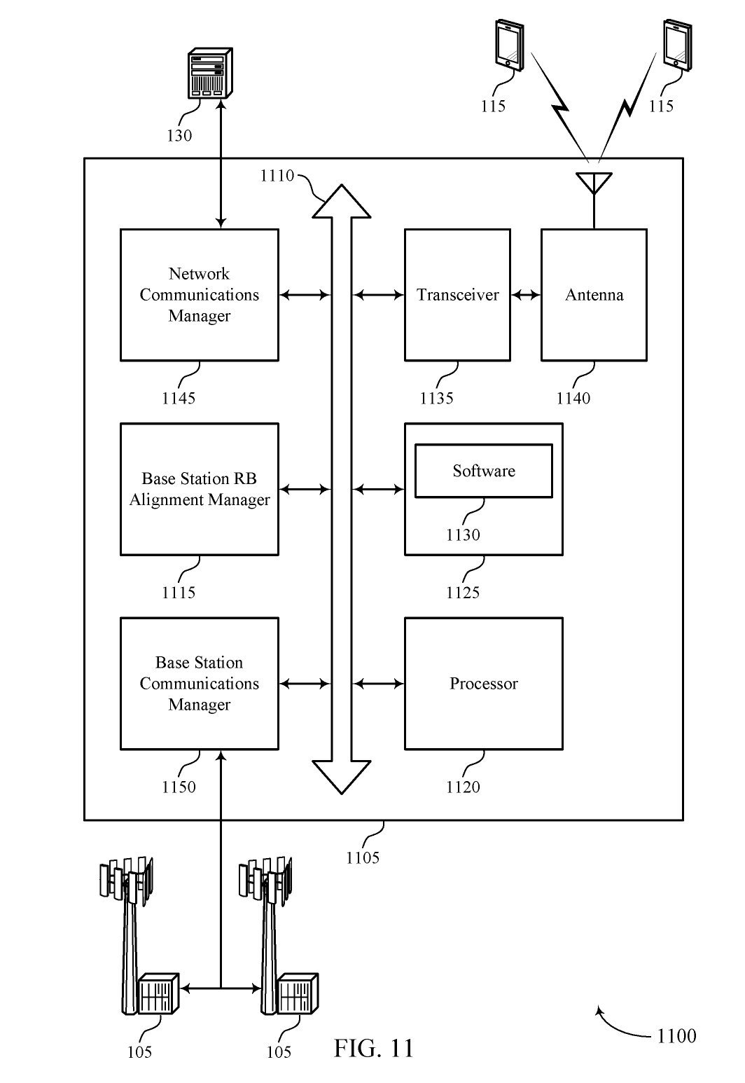

In the example of FIG. 1, base station 105-a may include a network RB alignment manager 101, which may identify an integer number of RBs that occupy less bandwidth than the system bandwidth, and identify a fractional bandwidth as a difference between the bandwidth of the integer number of RBs and the system bandwidth. This fractional bandwidth may be used, in some examples, to transmit information using one or more fractional RBs that may have a same or different numerology as the integer number of RBs. Additionally or alternatively, all or a portion of the fractional bandwidth may be used to provide a guard band between RBs. The network RB alignment manager 101 may, in some examples, select a placement scheme for placing the integer number of RBs, one or more fractional RBs, and/or one or more guard bands, within the system bandwidth. The network RB alignment manager 101 may be an example of a base station RB alignment manager 1115 as described below with reference to FIG. 11.

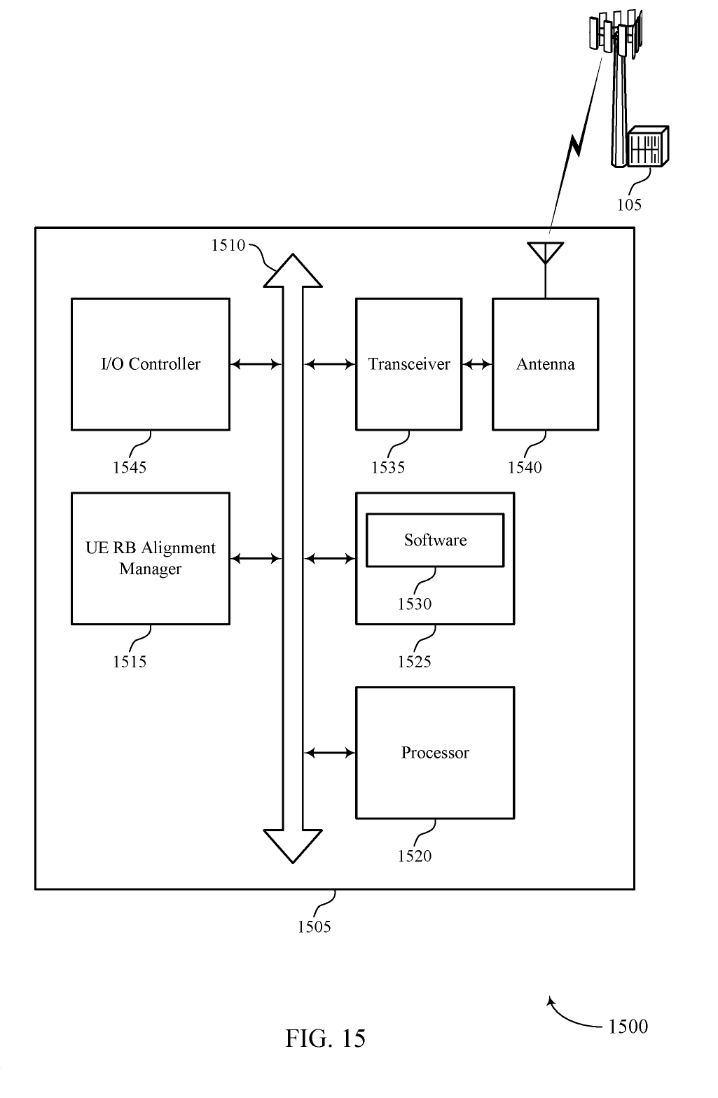

UEs 115 may include a UE RB alignment manager 102, which may identify an integer number of RBs for a received transmission over the system bandwidth, and identify any associated fractional bandwidth. The UE RB alignment manager 102 may identify the placement scheme for one or more fractional RBs and the integer number of RBs within the system bandwidth, and demodulate and decode the integer number of RBs, and/or the one or more fractional RBs, based at least in part on the placement scheme. The UE RB alignment manager 102 may be an example of a UE RB alignment manager 1515 as described below with reference to FIG. 15.

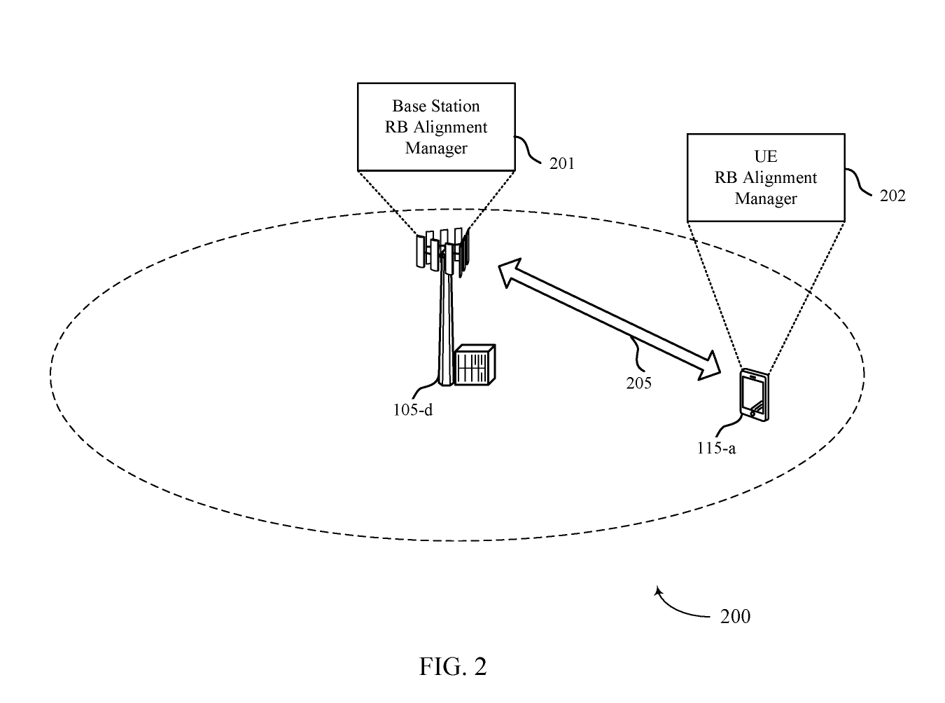

FIG. 2 illustrates an example of a portion of a wireless communication system 200 for resource block alignment in mixed numerology wireless transmissions in accordance with aspects of the present disclosure. Wireless communication system 200 may include a base station 105-d, and a UE 115-a, which may be examples of the corresponding devices described with reference to FIG. 1. In the example of FIG. 2, the base station 105-d may establish a connection 205 with the UE 115-a, which may be a carrier that is capable of supporting one or more different service types. In the example of FIG. 2, the wireless communication system 200 may operate according to a radio access technology (RAT) such as a 5G or NR RAT, although techniques described herein may be applied to any RAT and to systems that may concurrently use two or more different RATs.

As indicated above, in some examples the wireless communication system 200 may be a portion of a NR or 5G network. Based on growing demand for data and throughput anticipated for 5G, efficient use of RF spectrum may be necessary to support communications. Such efficient use may include adaptive numerology adjustment for transmissions based on a numerology of the associated transmission, as discussed herein. For example, in some deployments, as indicated above, a 5G or NR network may support multiple types of services, such as eMBB, URLLC, mMTC, etc., that may use different transmission numerologies.

In some examples, a basic tone spacing may be established for wireless communication system 200, and a total number of RBs that may be transmitted using a system bandwidth used for communications between base station 105-d and UE 115-a may correspond to a predetermined number of REs. For example, a basic tone spacing may be 15 kHz, and one RB may include 12 REs, using similar numerology as LTE deployments. A total number of RBs for 15 kHz tone spacing may thus be identified as Num RB 15 kHz, and the system bandwidth may be equally divisible by Num_RB_15 kHz. For transmissions that have different numerology, the tone spacing may be some multiple of the basic tone spacing, or 15 kHz*M in this example. The total number of RBs that may be transmitted using the system bandwidth may then be Num_RB_15 kHz/M. As indicated above, Num_RB_15 kHz may not be evenly dividable by M, which may result in a fractional bandwidth being present between a bandwidth occupied by an integer number of RBs with the different tone spacing and the system bandwidth. For example, if a system bandwidth is 10 MHz, the Num_RB_15 kHz may be 50. If the tone spacing is increased to 60 kHz for transmissions of a service, the value of M would be four, and the Num_RB_15 kHz/4=12.5 RBs. Thus, a fractional bandwidth corresponding to one-half of such an RB is present. According to aspects of the present disclosure, such fractional bandwidth may be used for data transmissions, to provide a guard band between RBs, or combinations thereof. Placement schemes for fractional RBs and/or guard bands are also provided.

In some examples, the base station 105-d may include a base station RB alignment manager 201, which may be an example of network RB alignment manager 101 of FIG. 1, and may be used to identify an integer number of RBs that occupy less bandwidth than the system bandwidth, and identify a fractional bandwidth as a difference between the bandwidth of the integer number of RBs and the system bandwidth, that may be used, in some examples, to transmit data using a same or different numerology as the integer number of RBs. Additionally or alternatively, all or a portion of the fractional bandwidth may be used to provide a guard band between RBs. The base station RB alignment manager 201 may, in some examples, select a placement scheme for placing the integer number of RBs, one or more fractional RBs, and/or one or more guard bands, within the system bandwidth. The base station RB alignment manager 201 may be an example of a base station RB alignment manager 1115 as described below with reference to FIG. 11.

The UE 115-a may include a UE RB alignment manager 202, which may be an example of UE RB alignment manager 102 of FIG. 1, and each of which may be used to identify an integer number of RBs for a received transmission over the system bandwidth, and identify any associated fractional bandwidth. The UE RB alignment manager 202 may identify the placement scheme for one or more fractional RBs and the integer number of RBs within the system bandwidth, and demodulate and decode the integer number of RBs, and/or the one or more fractional RBs, based at least in part on the placement scheme. The UE RB alignment manager 202 may be an example of a UE RB alignment manager 1515 as described below with reference to FIG. 15.

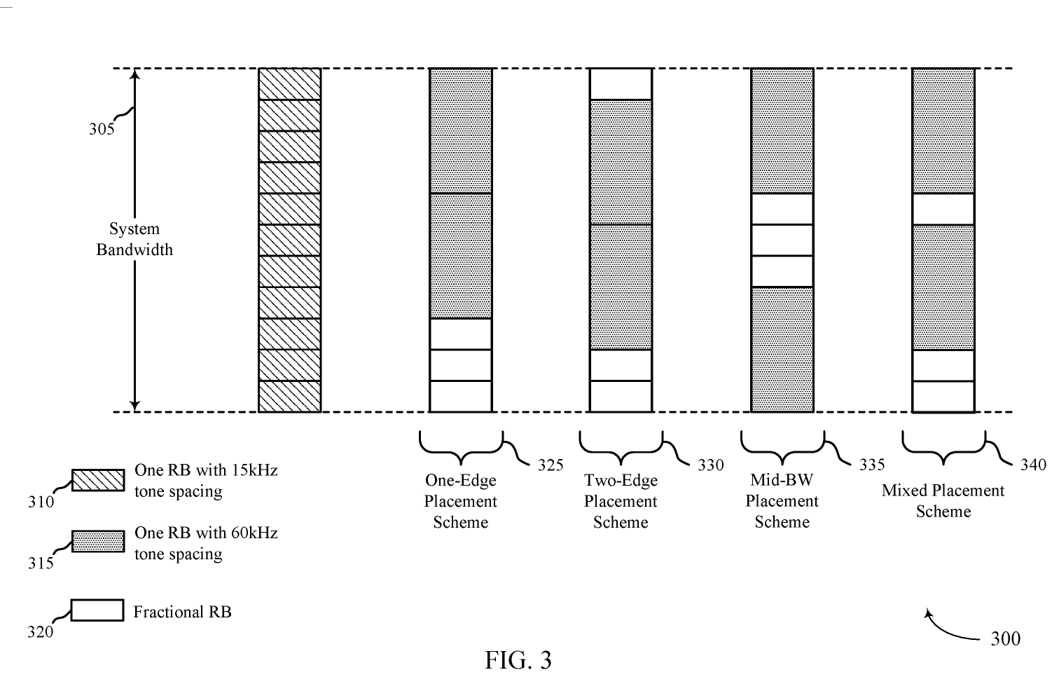

FIG. 3 illustrates examples of mixed numerology transmissions and fractional bandwidth placement schemes 300 in accordance with aspects of the present disclosure. In some examples, fractional bandwidth placement schemes 300 may be selected by a network access device such as a base station 105 of FIGS. 1-2, for communications for a particular service with a UE such as UEs 115 of FIGS. 1-2.

In this example, an integer number of 15 kHz RBs 310 may occupy an entire system bandwidth 305. Another service may use a different tone spacing, such as a 60 kHz tone spacing, and may have associated 60 kHz RBs 315, that each occupy four times as much bandwidth as a 15 kHz RB 310. In this example, eleven 15 kHz RBs 310 may occupy the system bandwidth 305, but only two integer 60 kHz RBs 315 may fit within the system bandwidth 305, thus leaving a fractional bandwidth that corresponds to three of the 15 kHz RBs 310. In the example of FIG. 3, the fractional bandwidth is occupied with three fractional RBs 320, that have bandwidth that corresponds to the 15 kHz RBs 310. The fractional RBs 320, as discussed in more detail below, may be used for data transmission using a 15 kHz numerology, a 60 kHz numerology, or some other numerology, and/or may be used to provide a guard band between RBs.

As indicated above, various placement schemes may be provided for fractional RBs 320. Such placement schemes may include a one-edge placement scheme 325, in which the fractional RBs 320 may be placed at one edge of the system bandwidth 305. A two-edge placement scheme 330 may place one or more fractional RB 320, or portions thereof, at each edge of the system bandwidth. The two-edge placement scheme 330 may provide for either symmetric or asymmetric placement of fractional RBs 320 at each edge of the system bandwidth 305. In examples where a portion of a fractional RB 320 are placed at each edge of the system bandwidth 305, one or more tones of a fractional RB 320 may be placed at each edge. For example, if one fractional RB 320 is present that corresponds to a 15 kHz RB 310 that includes 12 tones, six of the 15 kHz tones may be placed on one edge of the system bandwidth 305 and the other six 15 kHz tones may be placed on the other edge of the system bandwidth 305. Again, such placement of tones may be symmetric or asymmetric A mid-bandwidth placement scheme 335 may place one or more fractional RBs 320 between the edges of the system bandwidth 305. Such a mid-bandwidth placement scheme 335 may place the fractional RBs 320 centered at the middle of the system bandwidth 305, or offset from the middle of the system bandwidth 305. Additionally, combinations of the mid-bandwidth placement scheme 335 with one of the one-edge placement scheme 325 or two-edge placement scheme 330 may be used in a mixed placement scheme 340 where one or more of the fractional RBs 320 may be placed between edges of the system bandwidth 305 and one or more fractional RBs 320 placed at one or both edges of the system bandwidth 305.

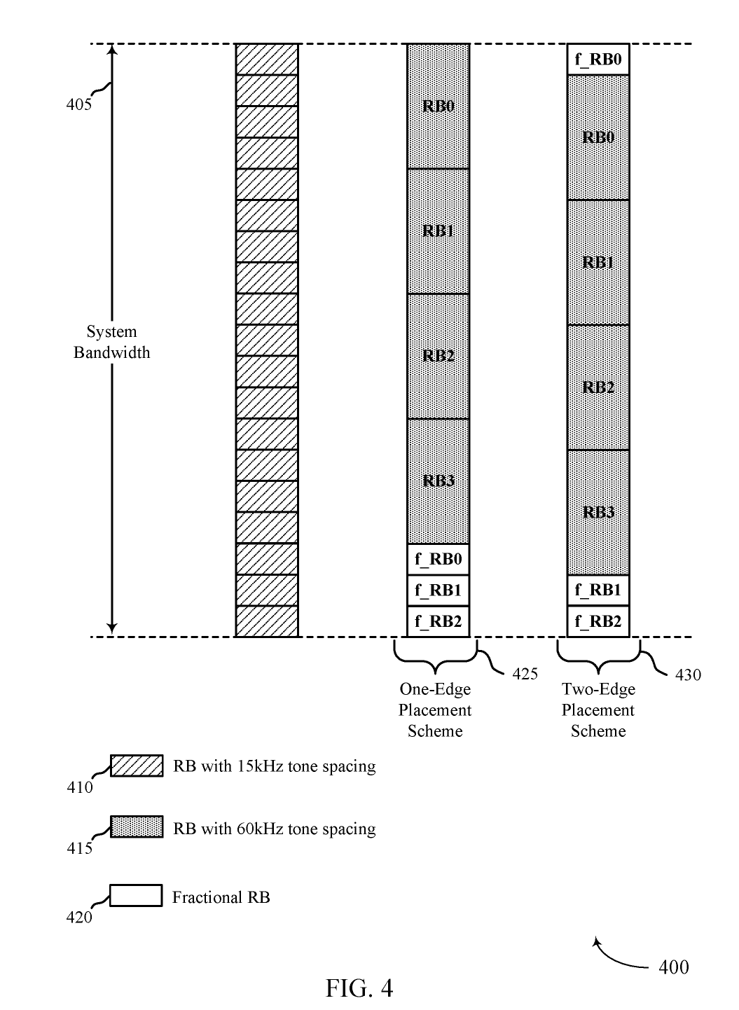

FIG. 4 illustrates an example of resource block alignments 400 in mixed numerology wireless transmissions in accordance with aspects of the present disclosure. In some examples, the resource block alignments 400 may be selected by a network access device such as a base station 105 of FIGS. 1-2, for communications for a particular service with a UE such as UEs 115 of FIGS. 1-2.

In this example, similarly as discussed in the example of FIG. 3, an integer number of 15 kHz RBs 410 may occupy an entire system bandwidth 405. Another service may have associated 60 kHz RBs 415, that each occupy four times as much bandwidth as a 15 kHz RB 410. In this example, 19 of the 15 kHz RBs 410 may occupy the system bandwidth 405, with four integer 60 kHz RBs 415 fitting within the system bandwidth 405, thus leaving a fractional bandwidth that corresponds to three of the 15 kHz RBs 410. In the example of FIG. 4, the fractional bandwidth is occupied with three fractional RBs 420, that have bandwidth that corresponds to the 15 kHz RBs 410. The example of FIG. 4 shows a one-edge placement scheme 425 and a two-edge placement scheme 430, although one or more other placement schemes may be used. The fractional RBs 420 and integer 60 kHz RBs 415 may be numbered sequentially either separately from each other, as illustrated in FIG. 4, or consecutively. For example, FIG. 4 illustrates each fractional RB being numbered as f_RB0 through f_RB2 irrespective of whether a one-edge placement scheme 425 or a two-edge placement scheme 430 is used. Likewise, each integer 60 kHz RB 415 is numbered as RB0 through RB3. In other examples, the different RBs may be simply numbered consecutively within the system bandwidth 405 irrespective of whether the RB is an integer RB or a fractional RB. In further examples, each tone of a fractional RB may be numbered consecutively within the system bandwidth 405, which may provide for numbering and identification of particular tones in cases where tones of a fractional RB 420 may be placed at different non-adjacent locations within system bandwidth 405. Also, as referred to herein, an integer RB may be an integer RB with respect to a numerology of a transmission that has a highest tone spacing, and a fractional RB may be a fraction of the integer RB. In some cases, as discussed herein, an even number of integer RBs may not occupy an entire system bandwidth 405.

The numbering of the RBs and/or fractional RB tones and the placement scheme may be identified by a base station and a UE based on implicit mapping, or through selection by the base station and signaling of the selection to a UE. In cases, where implicit mapping may be used to identify a numbering and placemen scheme, different numbering and placement schemes may be mapped in an established specification to specific system bandwidths and tone spacing. Thus, for a system bandwidth and a corresponding value of M, a predetermined placement and numbering of integer and fractional RBs may be identified. For example, in a system with a 10 MHz system bandwidth and a basic tone spacing of 15 kHz, base stations may always use a two-edge placement scheme with a predetermined number of fractional RBs placed at each edge of the system bandwidth 405.

In other cases, a base station may select a placement scheme and provide signaling to a UE that indicates the selected placement scheme, such as via a system information block (SIB) that is broadcast to the UE. In some cases, signaling to indicate a selected placement scheme may provide an index to a mapping of a set of placement schemes.

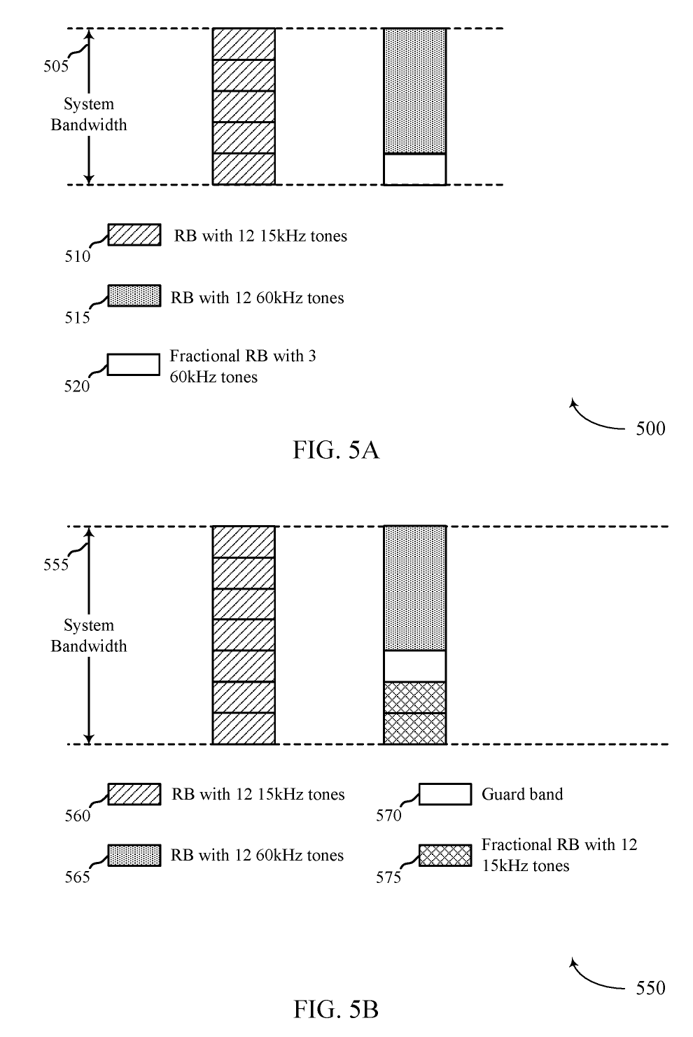

FIG. 5A and 5B illustrate examples of a resource block alignments 500 and 550 in mixed numerology wireless transmissions in accordance with aspects of the present disclosure. In some examples, the resource block alignments 500 and 550 may be selected by a network access device such as a base station 105 of FIGS. 1-2, for communications for a particular service with a UE such as UEs 115 of FIGS. 1-2. As indicated above, in some cases a fractional RB may be used for data transmission using a same numerology as an integer RB or using a different numerology as the integer RB.

In the example of FIG. 5A, similarly as discussed in the example of FIGS. 3 and 4, an integer number of 15 kHz RBs 510 may occupy an entire system bandwidth 505. Another service may have associated 60 kHz RBs 515, that each occupy four times as much bandwidth as a 15 kHz RB 510. The 15 kHz RBs 510 may include, for example, twelve 15 kHz tones, and the integer 60 kHz RB 515 may include twelve 60 kHz tones. In this example, five of the 15 kHz RBs 510 may occupy the system bandwidth 505, with one integer 60 kHz RB 515 fitting within the system bandwidth 505, thus leaving a fractional bandwidth that corresponds to one of the 15 kHz RBs 510. In the example of FIG. 5A, the fractional bandwidth is occupied with one fractional RB 520, that has bandwidth that corresponds to the 15 kHz RBs 510, and that includes three 60 kHz tones. Thus, the fractional RB 520 has a same tone spacing as integer 60 kHz RB, and a sub-RB allocation may be made for the fractional RB 520. In some examples, a minimum granularity may be provided for sub-RB allocations, such as, for example, a single tone, three tones, or 6 tones. Thus, the fractional RB 520 has a same numerology as the integer 60 kHz RB 515 and may be transmitted using tones directly adjacent to tones of the 60 kHz RB 515.

In the example of FIG. 5B, a different numerology may be used for data transmission in the fractional bandwidth. In this example, again an integer number of 15 kHz RBs 560 may occupy an entire system bandwidth 555. Another service may have associated 60 kHz RBs 565, that each occupy four times as much bandwidth as a 15 kHz RB 560. The 15 kHz RBs 560 may include, for example, twelve 15 kHz tones, and the integer 60 kHz RB 565 may include twelve 60 kHz tones. In this example, seven of the 15 kHz RBs 560 may occupy the system bandwidth 565, with one integer 60 kHz RB 565 fitting within the system bandwidth 555, thus leaving a fractional bandwidth that corresponds to three of the 15 kHz RBs 560. In the example of FIG. 5B, the fractional bandwidth is occupied with two fractional RBs 575, that have a bandwidth that corresponds to the 15 kHz RBs 510, and that includes twelve of the 15 kHz tones. Thus, the fractional RBs 575 provide a second integer number of RBs for a tone spacing of 15 kHz, and different numerologies are present for the integer 60 kHz RB 565 and the fractional RBs 575. In this example, a portion of the fractional bandwidth is reserved and used as a guard band 570, in order to provide some guard tones between fractional RBs 575 and the integer 60 kHz RB 565, which may reduce mutual interference between the RBs with different numerologies.

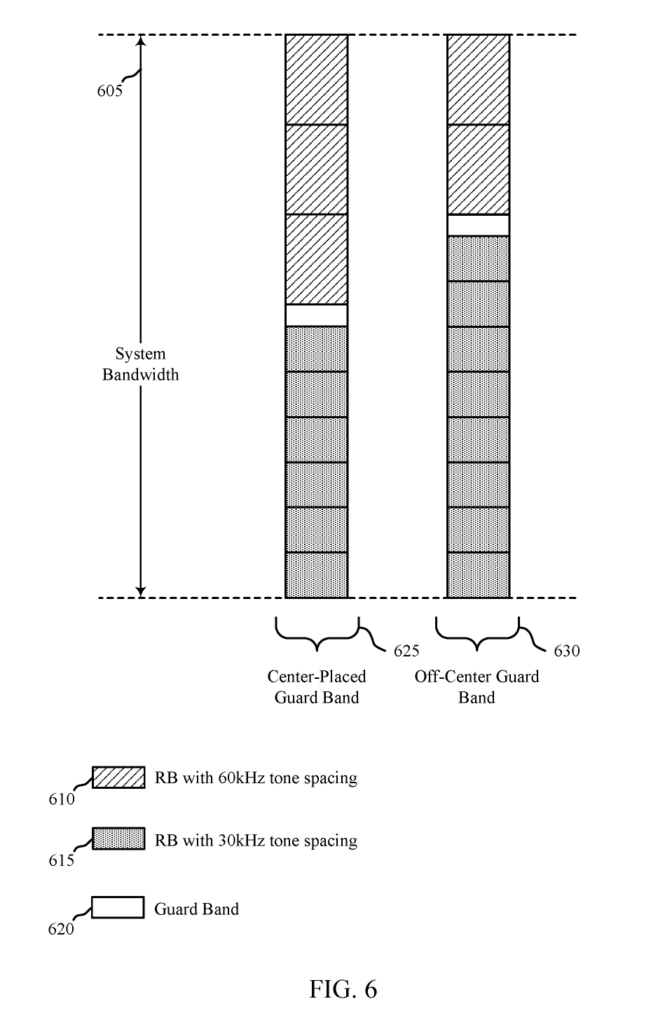

FIG. 6 illustrates further examples of resource block alignments 600 in mixed numerology wireless transmissions in accordance with aspects of the present disclosure. In some examples, the resource block alignments 600 may be selected by a network access device such as a base station 105 of FIGS. 1-2, for communications for a particular service with a UE such as UEs 115 of FIGS. 1-2. In these examples, fractional RBs may be used for data transmission using a different numerology as integer RBs.

In the example of FIG. 6, similarly as discussed in the example of FIGS. 3,4, and 5, a first set of 60 kHz RBs 610 may occupy a portion of system bandwidth 605. In this example, a second set of 30 kHz RBs 615 may occupy another portion of the system bandwidth 605. A fractional bandwidth of the system bandwidth 605 may be used as a guard band 620 between the first set of 60 kHz RBs 610 and the second set of 30 kHz RBs 615. For example, the system bandwidth 605 may be 5 MHz, and may thus support 25 RBs of 15 kHz tone spacing, and may also support three 60 kHz RBs 610 and six 30 kHz RBs 615, with a fractional bandwidth remaining that corresponds to one RB of 15 kHz as guard band 620. In this example, a mid-bandwidth placement scheme may be used for the fractional bandwidth used as guard band 620. In some examples, a center-placed guard band placement scheme 625 may be used, or an off-center guard band placement scheme 630 may be used. Thus, the guard band 620 may be placed at the center of system bandwidth 605, or off-center such that different numbers of RBs associated with different tone spacing may be used. In some examples, a base station may signal such a mixed numerology transmission and placement scheme to the UE using explicit signaling, such as via a SIB.

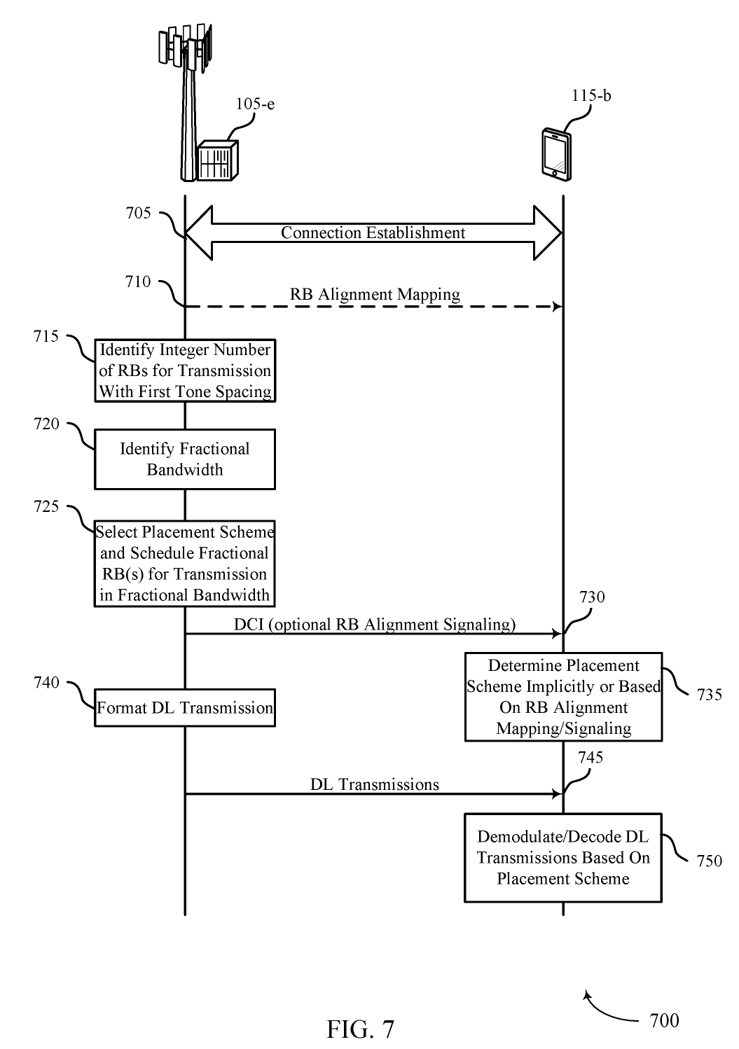

FIG. 7 illustrates an example of a process flow 700 for resource block alignment in mixed numerology wireless transmissions. Process flow 700 may include base station 105-e and UE 115-b, which may be examples of the corresponding devices described with reference to FIG. 1-2. The base station 105-e and the UE 115-b may establish a connection 705 according to established connection establishment techniques. In some examples, base station 105-e may transmit optional RB alignment mapping 710 and/or fractional RB placement scheme to the UE 115-b, such as via a SIB, for example.

At block 715, the base station 105-e may identify an integer number of RBs for transmission with a first tone spacing. For example, the integer number of RBs may be identified based on a tone spacing for a service that is transmitting data and a system bandwidth allocated for the transmission.

At block 720, the base station 105-e may identify a fractional bandwidth. Such a fractional bandwidth may be identified when the integer number of RBs occupy less than the allocated system bandwidth, and may be identified as a difference between a bandwidth occupied by the integer number of RBs and the system bandwidth.

At block 725, the base station 105-e may select a placement scheme for the integer number of RBs and one or more fractional RBs that may be present in the fractional bandwidth, and may schedule the fractional RBs for transmission of data in the fractional bandwidth. The placement scheme may be, as discussed above, a one-edge placement scheme, a two-edge placement scheme, a mid-bandwidth placement scheme, or combinations thereof. In some examples, the placement scheme may be selected based on system bandwidth, numerology, or the transmissions to be made to the UE 115-b, channel conditions, data to be transmitted, other factors, or any combination thereof. For example, a mid-bandwidth placement scheme for a guard band portion of the fractional bandwidth may be selected, along with a one-edge placement scheme for a fractional RB to be transmitted using a different numerology than a numerology of the integer number of RBs.

The base station 105-a may transmit downlink control information (DCI) 730, and optional RB alignment signaling that may indicate the RBs being transmitted, fractional RBs being transmitted, and/or guard band information. The DCI 730 may include, for example, a resource allocation for a subsequent downlink transmission that may include a fractional RB.

At block 735, the UE 115-b may determine a placement scheme associated with the downlink transmissions. Such a placement scheme may be determined implicitly, based on a tone spacing for the transmission and a system bandwidth, or may be based on explicit RB alignment mapping/signaling.

At block 740, the base station 105-e may format the downlink transmission to the UE 115-b. The downlink transmission may be formatted according to the integer number of RBs previously identified, as well as formatted to include any data transmission using fractional RBs that are to be transmitted using fractional bandwidth. The base station 105-a may then transmit the downlink transmissions 745. At block 750, the UE 115-b may receive the downlink transmission and demodulate/decode the received transmission according to the identified placement scheme.

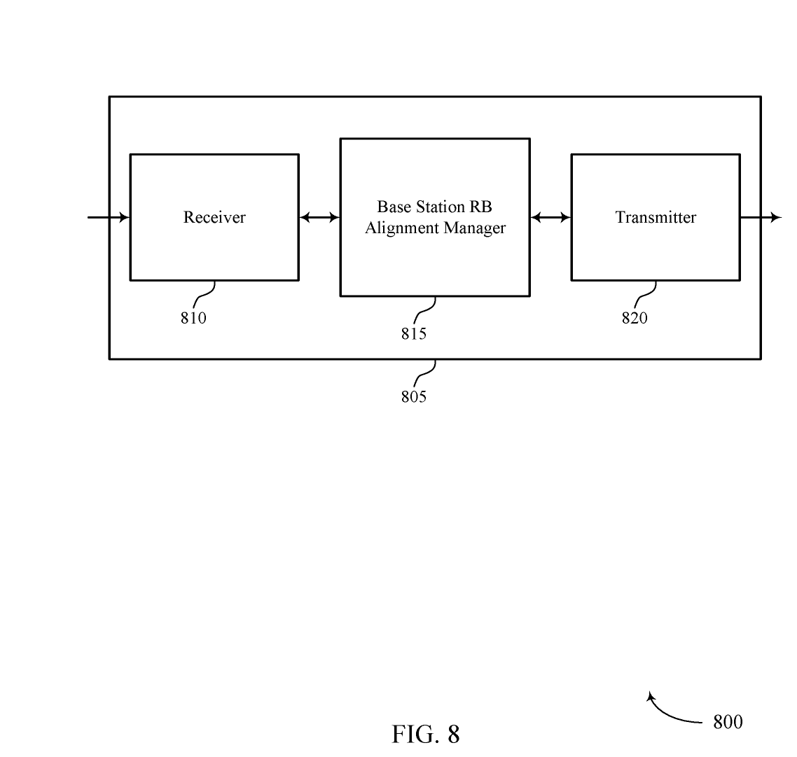

FIG. 8 shows a block diagram 800 of a wireless device 805 that supports resource block alignment in mixed numerology wireless transmissions in accordance with various aspects of the present disclosure. Wireless device 805 may be an example of aspects of a base station 105 as described with reference to FIG. 1. Wireless device 805 may include receiver 810, base station RB alignment manager 815, and transmitter 820. Wireless device 805 may also include a processor. Each of these components may be in communication with one another (e.g., via one or more buses).

Receiver 810 may receive information such as packets, user data, or control information associated with various information channels (e.g., control channels, data channels, and information related to resource block alignment in mixed numerology wireless transmissions, etc.). Information may be passed on to other components of the device. The receiver 810 may be an example of aspects of the transceiver 1135 described with reference to FIG. 11.

Base station RB alignment manager 815 may be an example of aspects of the network RB alignment manager 101, the base station RB alignment manager 201, or the base station RB alignment manager 1115 described with reference to FIGS. 1, 2, and 11. Base station RB alignment manager 815 may identify an integer number of RBs for transmission using a system bandwidth, where the integer number of RBs occupy less bandwidth than the system bandwidth, identify a fractional bandwidth as a difference between a bandwidth occupied by the integer number of RBs and the system bandwidth, identify one or more fractional RBs for transmission within at least a portion of the fractional bandwidth, and select a placement scheme for placing the integer number of RBs and the one or more fractional RBs within the system bandwidth.

Transmitter 820 may transmit signals generated by other components of the device. In some examples, the transmitter 820 may be collocated with a receiver 810 in a transceiver module. For example, the transmitter 820 may be an example of aspects of the transceiver 1135 described with reference to FIG. 11. The transmitter 820 may include a single antenna, or it may include a set of antennas. Transmitter 820 may transmit the integer number of RBs and/or one or more fractional RBs to a receiver using the placement scheme.

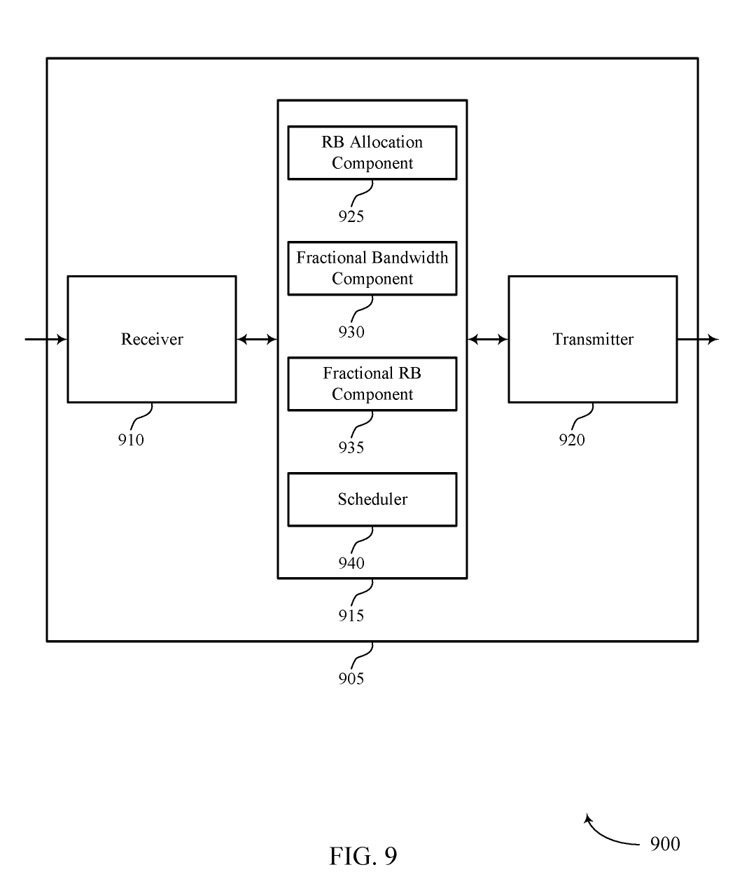

FIG. 9 shows a block diagram 900 of a wireless device 905 that supports resource block alignment in mixed numerology wireless transmissions in accordance with various aspects of the present disclosure. Wireless device 905 may be an example of aspects of a wireless device 805 or a base station 105 as described with reference to FIGS. 1 and 8. Wireless device 905 may include receiver 910, base station RB alignment manager 915, and transmitter 920. Wireless device 905 may also include a processor. Each of these components may be in communication with one another (e.g., via one or more buses).

Receiver 910 may receive information such as packets, user data, or control information associated with various information channels (e.g., control channels, data channels, and information related to resource block alignment in mixed numerology wireless transmissions, etc.). Information may be passed on to other components of the device. The receiver 910 may be an example of aspects of the transceiver 1135 described with reference to FIG. 11.

Base station RB alignment manager 915 may be an example of aspects of the network RB alignment manager 101, the base station RB alignment manager 201, or the base station RB alignment manager 1115 described with reference to FIGS. 1, 2, and 11. Base station RB alignment manager 915 may also include RB allocation component 925, fractional bandwidth component 930, fractional RB component 935, and scheduler 940.

RB allocation component 925 may identify an integer number of RBs for transmission using a system bandwidth, where the integer number of RBs occupy less bandwidth than the system bandwidth. In some cases, the integer number of RBs are associated with a first wireless service that uses a different numerology than a second wireless service.

Fractional bandwidth component 930 may identify a fractional bandwidth as a difference between a bandwidth occupied by the integer number of RBs and the system bandwidth.

Fractional RB component 935 may identify one or more fractional RBs for transmission within at least a portion of the fractional bandwidth. In some cases, the one or more fractional RBs have a same numerology as the integer number of RBs. In some cases, the one or more fractional RBs have a sub-allocation of fewer tones than a number of tones of each of the integer number of RBs.

Scheduler 940 may select a placement scheme for placing the integer number of RBs and the one or more fractional RBs within the system bandwidth. Such a placement scheme may include, for example, a one-edge placement scheme in which at least a portion of the fractional bandwidth is placed at an edge of the system bandwidth, a two-edge placement scheme in which a first portion of the fractional bandwidth is placed at a first edge of the system bandwidth and a second portion of the fractional bandwidth is placed at a second edge of the system bandwidth, or a mid-bandwidth placement scheme in which at least a portion of the fractional bandwidth is placed between two RBs of the integer number of RBs within the system bandwidth, or combinations thereof. In some cases, the first portion of the fractional bandwidth and the second portion of the fractional bandwidth are symmetric or asymmetric. In some cases, the placement scheme is identified based on the system bandwidth and a tone spacing associated with the integer number of RBs. In some cases, the integer number of RBs have a first numerology and the one or more fractional RBs have a second numerology that is different than the first numerology. In some cases, the one or more fractional RBs include a second integer number of RBs for the second numerology.

Transmitter 920 may transmit signals generated by other components of the device. In some examples, the transmitter 920 may be collocated with a receiver 910 in a transceiver module. For example, the transmitter 920 may be an example of aspects of the transceiver 1135 described with reference to FIG. 11. The transmitter 920 may include a single antenna, or it may include a set of antennas.

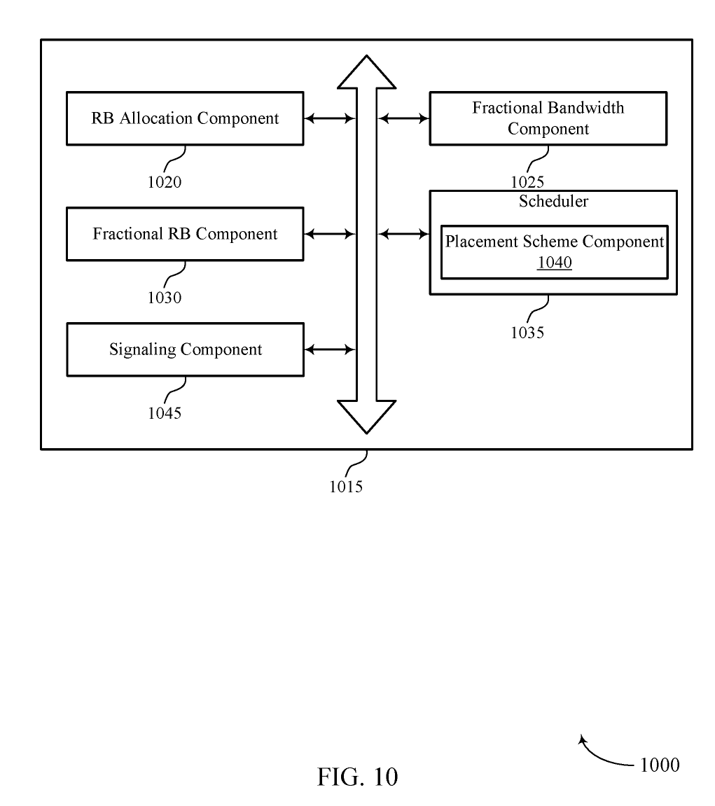

FIG. 10 shows a block diagram 1000 of a base station RB alignment manager 1015 that supports resource block alignment in mixed numerology wireless transmissions in accordance with various aspects of the present disclosure. The base station RB alignment manager 1015 may be an example of aspects of a network RB alignment manager 101, a base station RB alignment manager 201, a base station RB alignment manager 815, a base station RB alignment manager 915, or a base station RB alignment manager 1115 described with reference to FIGS. 1, 2, 8, 9, and 11. The base station RB alignment manager 1015 may include RB allocation component 1020, fractional bandwidth component 1025, fractional RB component 1030, scheduler 1035, placement scheme component 1040, and signaling component 1045. Each of these modules may communicate, directly or indirectly, with one another (e.g., via one or more buses).

RB allocation component 1020 may identify an integer number of RBs for transmission using a system bandwidth, where the integer number of RBs occupy less bandwidth than the system bandwidth. In some cases, the integer number of RBs are associated with a first wireless service that uses a different numerology than a second wireless service.

Fractional bandwidth component 1025 may identify a fractional bandwidth as a difference between a bandwidth occupied by the integer number of RBs and the system bandwidth.

Fractional RB component 1030 may identify one or more fractional RBs for transmission within at least a portion of the fractional bandwidth. In some cases, the one or more fractional RBs have a same numerology as the integer number of RBs. In some cases, the one or more fractional RBs have a sub-allocation of fewer tones than a number of tones of each of the integer number of RBs.

Scheduler 1035 may select a placement scheme for placing the integer number of RBs and the one or more fractional RBs within the system bandwidth. Such a placement scheme may include a one-edge placement scheme in which at least a portion of the fractional bandwidth is placed at one edge of the system bandwidth, a two-edge placement scheme in which a first portion of the fractional bandwidth is placed at a first edge of the system bandwidth and a second portion of the fractional bandwidth is placed at a second edge of the system bandwidth, or a mid-bandwidth placement scheme in which at least a portion of the fractional bandwidth is placed between two RBs of the integer number of RBs within the system bandwidth, or combinations thereof. In some cases, a first portion of the fractional bandwidth and a second portion of the fractional bandwidth are symmetric or asymmetric. In some cases, the placement scheme is identified based on the system bandwidth and a tone spacing associated with the integer number of RBs. In some cases, the integer number of RBs have a first numerology and the one or more fractional RBs have a second numerology that is different than the first numerology. In some cases, the one or more fractional RBs include a second integer number of RBs for the second numerology.

Placement scheme component 1040 may, in some cases, identify a location for one or more portions of the fractional bandwidth within the system bandwidth and identify an RB numbering scheme for the integer number of RBs and the one or more fractional RBs. In some cases, the placement scheme is implicitly determined based on the system bandwidth and a tone spacing for the integer number of RBs. In some cases, the one or more fractional RBs occupy a first portion of the fractional bandwidth and where a second portion of the fractional bandwidth is placed as a guard band between the integer number of RBs and the one or more fractional RBs.

Signaling component 1045 may transmit signaling to indicate the placement scheme. In some cases, the signaling is transmitted in a SIB to the receiver. In some cases, the signaling includes one or more bits that are mapped to a predetermined placement scheme.

FIG. 11 shows a diagram of a system 1100 including a device 1105 that supports resource block alignment in mixed numerology wireless transmissions in accordance with various aspects of the present disclosure. Device 1105 may be an example of or include the components of wireless device 805, wireless device 905, or a base station 105 as described above, e.g., with reference to FIGS. 1, 2, 7, 8 and 9. Device 1105 may include components for bi-directional voice and data communications including components for transmitting and receiving communications, including base station RB alignment manager 1115, processor 1120, memory 1125, software 1130, transceiver 1135, antenna 1140, network communications manager 1145, and base station communications manager 1150. The base station RB alignment manager 1115 may be an example of aspects of the network RB alignment manager 101, the base station RB alignment manager 201, a base station RB alignment manager 815, a base station RB alignment manager 915, or a base station RB alignment manager 1015 described with reference to FIGS. 1, 2, 8, 9, and 10. These components may be in electronic communication via one or more busses (e.g., bus 1110). Device 1105 may communicate wirelessly with one or more UEs 115.

Processor 1120 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., functions or tasks supporting resource block alignment in mixed numerology wireless transmissions).

Memory 1125 may include random access memory (RAM) and read only memory (ROM). The memory 1125 may store computer-readable, computer-executable software 1130 including instructions that, when executed, cause the processor to perform various functions described herein. In some cases, the memory 1125 may contain, among other things, a basic input/output system (BIOS) which may control basic hardware and/or software operation such as the interaction with peripheral components or devices.

Software 1130 may include code to implement aspects of the present disclosure, including code to support resource block alignment in mixed numerology wireless transmissions. Software 1130 may be stored in a non-transitory computer-readable medium such as system memory or other memory. In some cases, the software 1130 may not be directly executable by the processor but may cause a computer (e.g., when compiled and executed) to perform functions described herein.

Transceiver 1135 may communicate bi-directionally, via one or more antennas, wired, or wireless links as described above. For example, the transceiver 1135 may represent a wireless transceiver and may communicate bi-directionally with another wireless transceiver. The transceiver 1135 may also include a modem to modulate the packets and provide the modulated packets to the antennas for transmission, and to demodulate packets received from the antennas.

In some cases, the wireless device may include a single antenna 1140. However, in some cases the device may have more than one antenna 1140, which may be capable of concurrently transmitting or receiving multiple wireless transmissions.

Network communications manager 1145 may manage communications with the core network (e.g., via one or more wired backhaul links). For example, the network communications manager 1145 may manage the transfer of data communications for client devices, such as one or more UEs 115.

Base station communications manager 1150 may manage communications with other base station 105, and may include a controller or scheduler for controlling communications with UEs 115 in cooperation with other base stations 105. For example, the base station communications manager 1150 may coordinate scheduling for transmissions to UEs 115 for various interference mitigation techniques such as beamforming or joint transmission. In some examples, base station communications manager 1150 may provide an X2 interface within an LTE/LTE-A wireless communication network technology to provide communication between base stations 105.

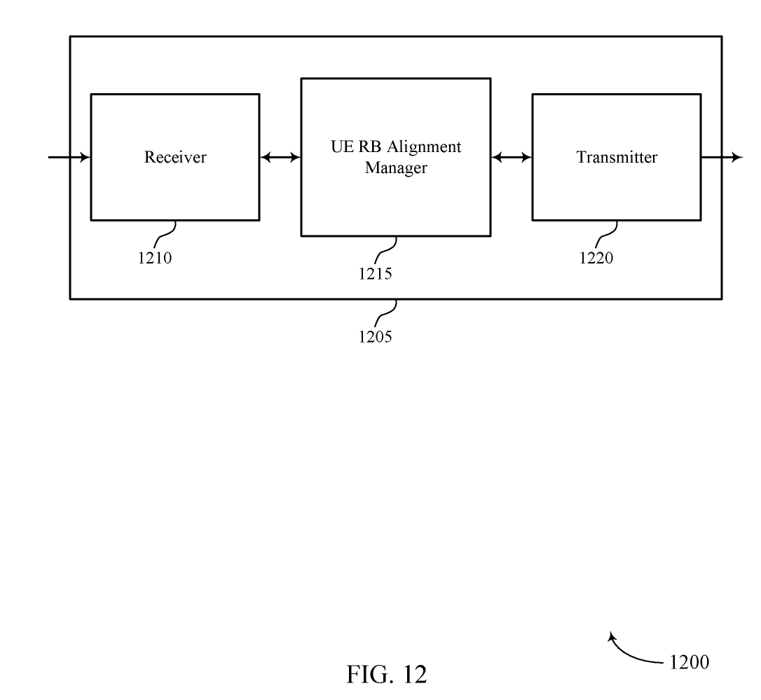

FIG. 12 shows a block diagram 1200 of a wireless device 1205 that supports resource block alignment in mixed numerology wireless transmissions in accordance with various aspects of the present disclosure. Wireless device 1205 may be an example of aspects of a UE 115 as described with reference to FIG. 1, 2, or 7. Wireless device 1205 may include receiver 1210, UE RB alignment manager 1215, and transmitter 1220. Wireless device 1205 may also include a processor. Each of these components may be in communication with one another (e.g., via one or more buses).

Receiver 1210 may receive information such as packets, user data, or control information associated with various information channels (e.g., control channels, data channels, and information related to resource block alignment in mixed numerology wireless transmissions, etc.). Information may be passed on to other components of the device. The receiver 1210 may be an example of aspects of the transceiver 1535 described with reference to FIG. 15.

UE RB alignment manager 1215 may be an example of aspects of the UE RB alignment manager 102, the UE RB alignment manager 202, or the UE RB alignment manager 1515 described with reference to FIGS. 1, 2, and 15. UE RB alignment manager 1215 may identify an integer number of RBs for a received transmission over a system bandwidth, where the integer number of RBs occupy less bandwidth than the system bandwidth, identify a fractional bandwidth of the received transmission based at least in part of a difference between a bandwidth occupied by the integer number of RBs and the system bandwidth, identify one or more fractional RBs within at least a portion of the fractional bandwidth, identify a placement scheme for the fractional RBs and the integer number of RBs within the system bandwidth, and demodulate and decode the integer number of RBs based on the placement scheme.

Transmitter 1220 may transmit signals generated by other components of the device. In some examples, the transmitter 1220 may be collocated with a receiver 1210 in a transceiver module. For example, the transmitter 1220 may be an example of aspects of the transceiver 1535 described with reference to FIG. 15. The transmitter 1220 may include a single antenna, or it may include a set of antennas.

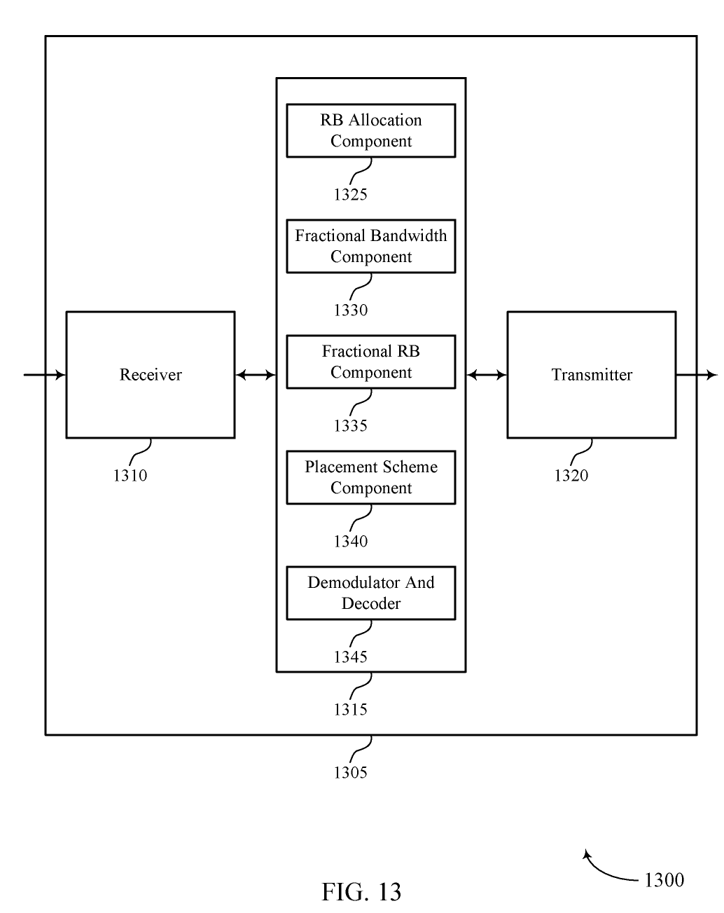

FIG. 13 shows a block diagram 1300 of a wireless device 1305 that supports resource block alignment in mixed numerology wireless transmissions in accordance with various aspects of the present disclosure. Wireless device 1305 may be an example of aspects of a wireless device 1205 or a UE 115 as described with reference to FIGS. 1 and 12. Wireless device 1305 may include receiver 1310, UE RB alignment manager 1315, and transmitter 1320. Wireless device 1305 may also include a processor. Each of these components may be in communication with one another (e.g., via one or more buses).

Receiver 1310 may receive information such as packets, user data, or control information associated with various information channels (e.g., control channels, data channels, and information related to resource block alignment in mixed numerology wireless transmissions, etc.). Information may be passed on to other components of the device. The receiver 1310 may be an example of aspects of the transceiver 1535 described with reference to FIG. 15.

UE RB alignment manager 1315 may be an example of aspects of the UE RB alignment manager 102, the UE RB alignment manager 202, or the UE RB alignment manager 1515 described with reference to FIG. 15. UE RB alignment manager 1315 may also include RB allocation component 1325, fractional bandwidth component 1330, fractional RB component 1335, placement scheme component 1340, and demodulator and decoder 1345.

RB allocation component 1325 may identify an integer number of RBs for a received transmission over a system bandwidth, where the integer number of RBs occupy less bandwidth than the system bandwidth. In some cases, the integer number of RBs are associated with a first wireless service that uses a different numerology than a second wireless service.

Fractional bandwidth component 1330 may identify a fractional bandwidth of the received transmission based at least in part of a difference between a bandwidth occupied by the integer number of RBs and the system bandwidth.

Fractional RB component 1335 may identify one or more fractional RBs within at least a portion of the fractional bandwidth. In some cases, the one or more fractional RBs have a same numerology as the integer number of RBs. In some cases, the integer number of RBs have a first numerology and the one or more fractional RBs have a second numerology that is different than the first numerology. In some cases, the one or more fractional RBs include a second integer number of RBs for the second numerology.

Placement scheme component 1340 may identify a placement scheme for the fractional RBs and the integer number of RBs within the system bandwidth. Such a placement scheme may include a one-edge placement scheme in which at least a portion of the fractional bandwidth is placed at one edge of the system bandwidth, a two-edge placement scheme in which a first portion of the fractional bandwidth is placed at a first edge of the system bandwidth and a second portion of the fractional bandwidth is placed at a second edge of the system bandwidth, or a mid-bandwidth placement scheme in which at least a portion of the fractional bandwidth is placed between two RBs within the system bandwidth. In some cases, a first portion of the fractional bandwidth and a second portion of the fractional bandwidth are symmetric or asymmetric. In some cases, the placement scheme includes a location for one or more portions of the fractional bandwidth within the system bandwidth and an RB numbering scheme for the integer number of RBs and the one or more fractional RBs transmitted within the fractional bandwidth. In some cases, the placement scheme is determined implicitly based on the system bandwidth and a tone spacing of the integer number of RBs. In some cases, the one or more fractional RBs occupy a first portion of the fractional bandwidth and where a second portion of the fractional bandwidth is placed as a guard band between the integer number of RBs and the one or more fractional RBs.

Demodulator and decoder 1345 may demodulate and decoding the integer number of RBs based on the placement scheme.

Transmitter 1320 may transmit signals generated by other components of the device. In some examples, the transmitter 1320 may be collocated with a receiver 1310 in a transceiver module. For example, the transmitter 1320 may be an example of aspects of the transceiver 1535 described with reference to FIG. 15. The transmitter 1320 may include a single antenna, or it may include a set of antennas.

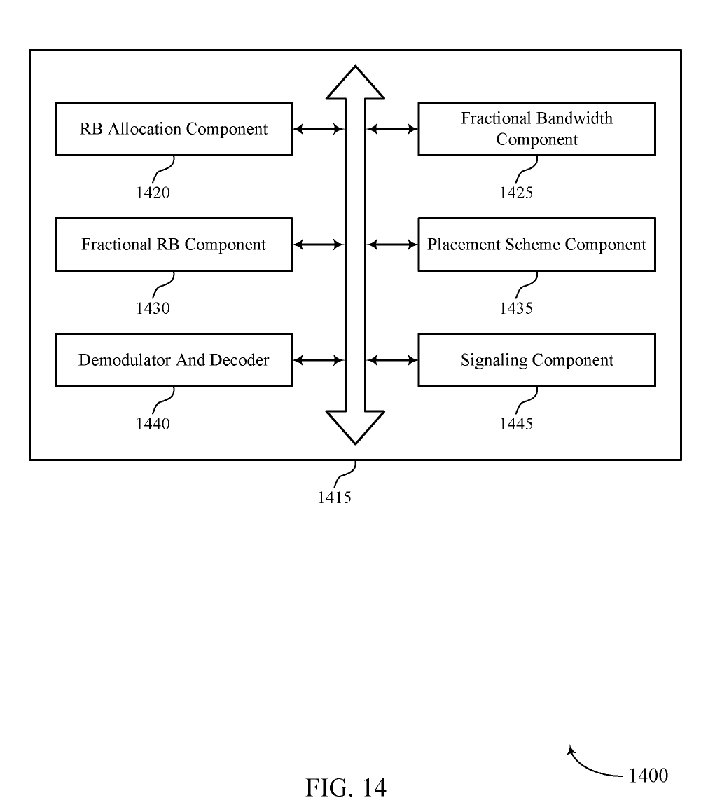

FIG. 14 shows a block diagram 1400 of a UE RB alignment manager 1415 that supports resource block alignment in mixed numerology wireless transmissions in accordance with various aspects of the present disclosure. The UE RB alignment manager 1415 may be an example of aspects of the UE RB alignment manager 102, the UE RB alignment manager 202, or UE RB alignment manager 1515 described with reference to FIGS. 1, 2, 12, 13, and 15. The UE RB alignment manager 1415 may include RB allocation component 1420, fractional bandwidth component 1425, fractional RB component 1430, placement scheme component 1435, demodulator and decoder 1440, and signaling component 1445. Each of these modules may communicate, directly or indirectly, with one another (e.g., via one or more buses).

RB allocation component 1420 may identify an integer number of resource blocks (RBs) for a received transmission over a system bandwidth, where the integer number of RBs occupy less bandwidth than the system bandwidth. In some cases, the integer number of RBs are associated with a first wireless service that uses a different numerology than a second wireless service.

Fractional bandwidth component 1425 may identify a fractional bandwidth of the received transmission based at least in part of a difference between a bandwidth occupied by the integer number of RBs and the system bandwidth.

Fractional RB component 1430 may identify one or more fractional RBs within at least a portion of the fractional bandwidth. In some cases, the one or more fractional RBs have a same numerology as the integer number of RBs. In some cases, the integer number of RBs have a first numerology and the one or more fractional RBs have a second numerology that is different than the first numerology. In some cases, the one or more fractional RBs include a second integer number of RBs for the second numerology.

Placement scheme component 1435 may identify a placement scheme for the fractional RBs and the integer number of RBs within the system bandwidth. In some cases, the identifying the placement scheme includes one or more of identifying a one-edge placement scheme in which at least a portion of the fractional bandwidth is placed at one edge of the system bandwidth, identifying a two-edge placement scheme in which a first portion of the fractional bandwidth is placed at a first edge of the system bandwidth and a second portion of the fractional bandwidth is placed at a second edge of the system bandwidth, or identifying a mid-bandwidth placement scheme in which at least a portion of the fractional bandwidth is placed between two RBs within the system bandwidth. In some cases, a first portion of the fractional bandwidth and a second portion of the fractional bandwidth are symmetric or asymmetric. In some cases, the placement scheme includes a location for one or more portions of the fractional bandwidth within the system bandwidth and an RB numbering scheme for the integer number of RBs and the one or more fractional RBs transmitted within the fractional bandwidth. In some cases, the placement scheme is determined implicitly based on the system bandwidth and a tone spacing of the integer number of RBs. In some cases, the one or more fractional RBs occupy a first portion of the fractional bandwidth and where a second portion of the fractional bandwidth is placed as a guard band between the integer number of RBs and the one or more fractional RBs.

Demodulator and decoder 1440 may demodulate and decoding the integer number of RBs based on the placement scheme.

Signaling component 1445 may receive signaling to indicate the placement scheme. In some cases, the signaling is received in a SIB. In some cases, the signaling includes one or more bits that are mapped to a predetermined placement scheme.

FIG. 15 shows a diagram of a system 1500 including a device 1505 that supports resource block alignment in mixed numerology wireless transmissions in accordance with various aspects of the present disclosure. Device 1505 may be an example of or include the components of UE 115 as described above, e.g., with reference to FIG. 1. Device 1505 may include components for bi-directional voice and data communications including components for transmitting and receiving communications, including UE RB alignment manager 1515, processor 1520, memory 1525, software 1530, transceiver 1535, antenna 1540, and I/O controller 1545. These components may be in electronic communication via one or more busses (e.g., bus 1510). Device 1505 may communicate wirelessly with one or more base stations 105.

Processor 1520 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1520 may be configured to operate a memory array using a memory controller. In other cases, a memory controller may be integrated into processor 1520. Processor 1520 may be configured to execute computer-readable instructions stored in a memory to perform various functions (e.g., functions or tasks supporting resource block alignment in mixed numerology wireless transmissions).

Memory 1525 may include RAM and ROM. The memory 1525 may store computer-readable, computer-executable software 1530 including instructions that, when executed, cause the processor to perform various functions described herein. In some cases, the memory 1525 may contain, among other things, a BIOS which may control basic hardware and/or software operation such as the interaction with peripheral components or devices.

Software 1530 may include code to implement aspects of the present disclosure, including code to support resource block alignment in mixed numerology wireless transmissions. Software 1530 may be stored in a non-transitory computer-readable medium such as system memory or other memory. In some cases, the software 1530 may not be directly executable by the processor but may cause a computer (e.g., when compiled and executed) to perform functions described herein.

Transceiver 1535 may communicate bi-directionally, via one or more antennas, wired, or wireless links as described above. For example, the transceiver 1535 may represent a wireless transceiver and may communicate bi-directionally with another wireless transceiver. The transceiver 1535 may also include a modem to modulate the packets and provide the modulated packets to the antennas for transmission, and to demodulate packets received from the antennas.

In some cases, the wireless device may include a single antenna 1540. However, in some cases the device may have more than one antenna 1540, which may be capable of concurrently transmitting or receiving multiple wireless transmissions.

I/O controller 1545 may manage input and output signals for device 1505. I/O controller 1545 may also manage peripherals not integrated into device 1505. In some cases, I/O controller 1545 may represent a physical connection or port to an external peripheral. In some cases, I/O controller 1545 may utilize an operating system such as iOS®, ANDROID®, MS-DOS®, MS-WINDOWS®, OS/2®, UNIX®, LINUX®, or another known operating system.

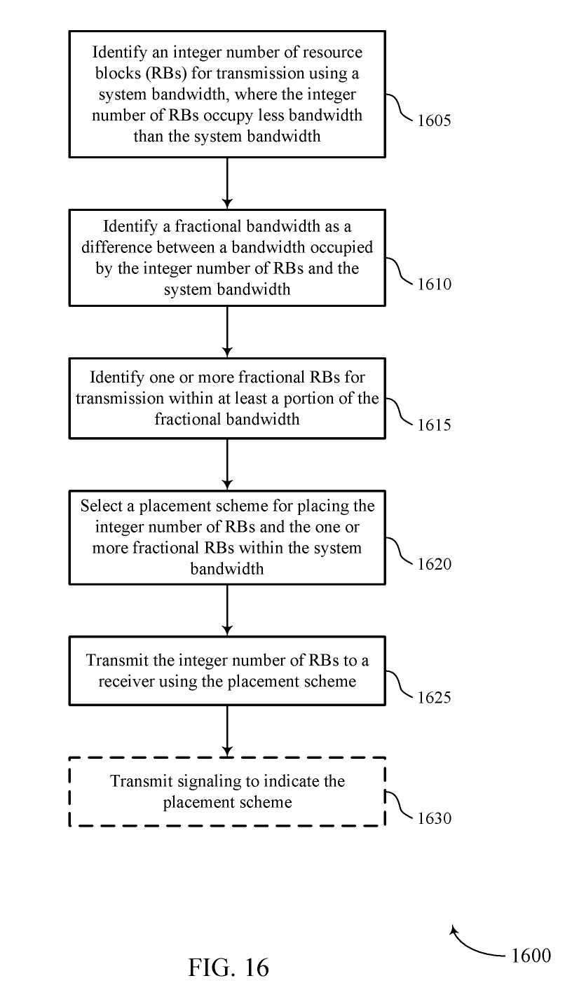

FIG. 16 shows a flowchart illustrating a method 1600 for resource block alignment in mixed numerology wireless transmissions in accordance with various aspects of the present disclosure. The operations of method 1600 may be implemented by a base station 105 or its components as described herein. For example, the operations of method 1600 may be performed by a base station RB alignment manager as described with reference to FIGS. 8 through 11. In some examples, a base station 105 may execute a set of codes to control the functional elements of the device to perform the functions described below. Additionally or alternatively, the base station 105 may perform aspects the functions described below using special-purpose hardware.

At block 1605 the base station 105 may identify an integer number of RBs for transmission using a system bandwidth, where the integer number of RBs occupy less bandwidth than the system bandwidth. The operations of block 1605 may be performed according to the methods described with reference to FIGS. 2 through 7. In certain examples, aspects of the operations of block 1605 may be performed by a RB allocation component as described with reference to FIGS. 8 through 11.

At block 1610 the base station 105 may identify a fractional bandwidth as a difference between a bandwidth occupied by the integer number of RBs and the system bandwidth. The operations of block 1610 may be performed according to the methods described with reference to FIGS. 2 through 7. In certain examples, aspects of the operations of block 1610 may be performed by a fractional bandwidth component as described with reference to FIGS. 8 through 11.

At block 1615 the base station 105 may identify one or more fractional RBs for transmission within at least a portion of the fractional bandwidth. The operations of block 1615 may be performed according to the methods described with reference to FIGS. 2 through 7. In certain examples, aspects of the operations of block 1615 may be performed by a fractional RB component as described with reference to FIGS. 8 through 11.

At block 1620 the base station 105 may select a placement scheme for placing the integer number of RBs and the one or more fractional RBs within the system bandwidth. The operations of block 1620 may be performed according to the methods described with reference to FIGS. 2 through 7. In certain examples, aspects of the operations of block 1620 may be performed by a scheduler as described with reference to FIGS. 8 through 11.

At block 1625 the base station 105 may transmit the integer number of RBs to a receiver using the placement scheme. The operations of block 1625 may be performed according to the methods described with reference to FIGS. 2 through 7. In certain examples, aspects of the operations of block 1625 may be performed by a transmitter as described with reference to FIGS. 8 through 11.

At optional block 1630 the base station 105 may optionally transmit signaling to indicate the placement scheme. The operations of block 1630 may be performed according to the methods described with reference to FIGS. 2 through 7. In certain examples, aspects of the operations of block 1630 may be performed by a signaling component as described with reference to FIGS. 8 through 11.

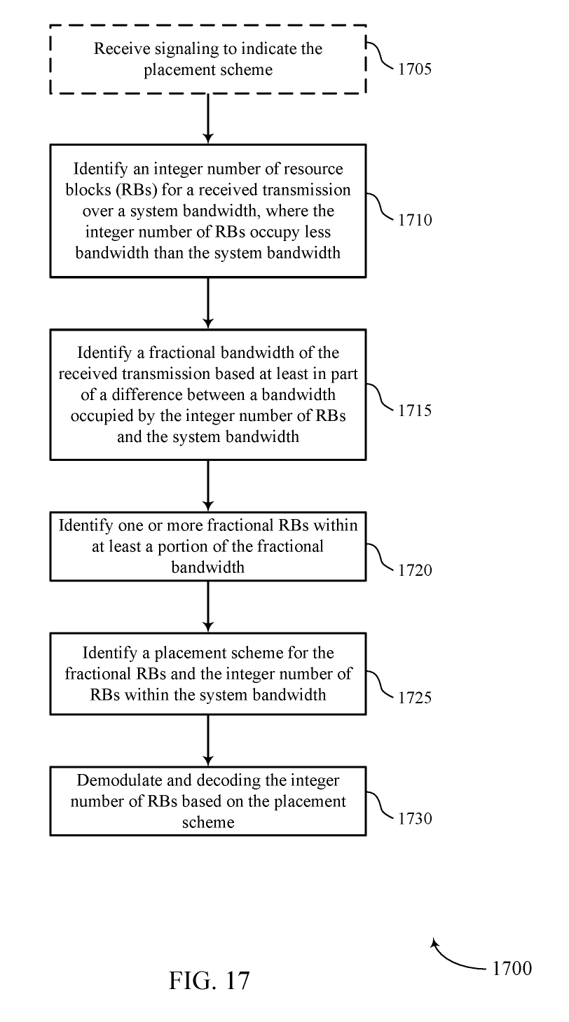

FIG. 17 shows a flowchart illustrating a method 1700 for resource block alignment in mixed numerology wireless transmissions in accordance with various aspects of the present disclosure. The operations of method 1700 may be implemented by a UE 115 or its components as described herein. For example, the operations of method 1700 may be performed by a UE RB alignment manager as described with reference to FIGS. 12 through 15. In some examples, a UE 115 may execute a set of codes to control the functional elements of the device to perform the functions described below. Additionally or alternatively, the UE 115 may perform aspects the functions described below using special-purpose hardware.

At optional block 1705 the UE 115 may optionally receive signaling to indicate the placement scheme. The operations of block 1730 may be performed according to the methods described with reference to FIGS. 2 through 7. In certain examples, aspects of the operations of block 1730 may be performed by a signaling component as described with reference to FIGS. 12 through 15.

At block 1710 the UE 115 may identify an integer number of resource blocks (RBs) for a received transmission over a system bandwidth, wherein the integer number of RBs occupy less bandwidth than the system bandwidth. The operations of block 1710 may be performed according to the methods described with reference to FIGS. 2 through 7. In certain examples, aspects of the operations of block 1710 may be performed by a RB allocation component as described with reference to FIGS. 12 through 15.

At block 1715 the UE 115 may identify a fractional bandwidth of the received transmission based at least in part of a difference between a bandwidth occupied by the integer number of RBs and the system bandwidth. The operations of block 1715 may be performed according to the methods described with reference to FIGS. 2 through 7. In certain examples, aspects of the operations of block 1715 may be performed by a fractional bandwidth component as described with reference to FIGS. 12 through 15.

At block 1720 the UE 115 may identify one or more fractional RBs within at least a portion of the fractional bandwidth. The operations of block 1720 may be performed according to the methods described with reference to FIGS. 2 through 7. In certain examples, aspects of the operations of block 1720 may be performed by a fractional RB component as described with reference to FIGS. 12 through 15.

At block 1725 the UE 115 may identify a placement scheme for the fractional RBs and the integer number of RBs within the system bandwidth. The operations of block 1725 may be performed according to the methods described with reference to FIGS. 2 through 7. In certain examples, aspects of the operations of block 1725 may be performed by a placement scheme component as described with reference to FIGS. 12 through 15.

At block 1730 the UE 115 may demodulate and decoding the integer number of RBs based at least in part on the placement scheme. The operations of block 1730 may be performed according to the methods described with reference to FIGS. 2 through 7. In certain examples, aspects of the operations of block 1730 may be performed by a demodulator and decoder as described with reference to FIGS. 12 through 15.

It should be noted that the methods described above describe possible implementations, and that the operations may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP LTE and LTE-A are releases of UMTS that use E-UTRA. UTRA, E-UTRA, UMTS, LTE, LTE-A, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE or an NR system may be described for purposes of example, and LTE or NR terminology may be used in much of the description, the techniques described herein are applicable beyond LTE or NR applications.

In LTE/LTE-A networks, including such networks described herein, the term evolved node B (eNB) may be generally used to describe the base stations. The wireless communications system or systems described herein may include a heterogeneous LTE/LTE-A or NR network in which different types of evolved node B (eNBs) provide coverage for various geographical regions. For example, each eNB, gNB or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), next generation NodeB (gNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, gNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communication system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary operation that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
identifying an integer number of resource blocks (RBs) for transmission using a system bandwidth, wherein the integer number of RBs occupy less bandwidth than the system bandwidth;
identifying a fractional bandwidth as a difference between a bandwidth occupied by the integer number of RBs and the system bandwidth;
identifying one or more fractional RBs within at least a portion of the fractional bandwidth;
selecting a placement scheme for placing the integer number of RBs and the one or more fractional RBs within the system bandwidth; and
transmitting information over the integer number of RBs to a receiver using the placement scheme.

2. The method of claim 1, wherein the integer number of RBs are associated with a first wireless service that uses a different numerology than a second wireless service.

3. The method of claim 1, wherein the selecting the placement scheme comprises one or more of:
selecting a one-edge placement scheme in which at least a portion of the fractional bandwidth is placed at one edge of the system bandwidth;
selecting a two-edge placement scheme in which a first portion of the fractional bandwidth is placed at a first edge of the system bandwidth and a second portion of the fractional bandwidth is placed at a second edge of the system bandwidth; or
selecting a mid-bandwidth placement scheme in which at least a portion of the fractional bandwidth is placed between two RBs of the integer number of RBs within the system bandwidth.

4. The method of claim 3, wherein the first portion of the fractional bandwidth and the second portion of the fractional bandwidth are symmetric or asymmetric.

5. The method of claim 1, wherein the placement scheme is identified based at least in part on the system bandwidth and a tone spacing associated with the integer number of RBs.

6. The method of claim 1, wherein the placement scheme comprises a location for one or more portions of the fractional bandwidth within the system bandwidth and an RB numbering scheme for the integer number of RBs and the one or more fractional RBs.

7. The method of claim 6, wherein the placement scheme is implicitly determined based at least in part on the system bandwidth and a tone spacing for the integer number of RBs.

8. The method of claim 1, further comprising:
transmitting signaling to indicate the placement scheme.

9. The method of claim 8, wherein the signaling is transmitted in a system information block (SIB) to the receiver.

10. The method of claim 8, wherein the signaling comprises one or more bits that are mapped to a predetermined placement scheme.

11. The method of claim 1, wherein the one or more fractional RBs have a same numerology as the integer number of RBs.

12. The method of claim 11, wherein the one or more fractional RBs have a sub-allocation of fewer tones than a number of tones of each of the integer number of RBs.

13. The method of claim 1, wherein the integer number of RBs have a first numerology and the one or more fractional RBs have a second numerology that is different than the first numerology.

14. The method of claim 13, wherein the one or more fractional RBs comprise a second integer number of RBs for the second numerology.

15. The method of claim 13, wherein the one or more fractional RBs occupy a first portion of the fractional bandwidth and wherein a second portion of the fractional bandwidth is placed as a guard band between the integer number of RBs and the one or more fractional RBs.

16. A method for wireless communication, comprising:
identifying an integer number of resource blocks (RBs) for a received transmission over a system bandwidth, wherein the integer number of RBs occupy less bandwidth than the system bandwidth;
identifying a fractional bandwidth of the received transmission based at least in part of a difference between a bandwidth occupied by the integer number of RBs and the system bandwidth;
identifying one or more fractional RBs within at least a portion of the fractional bandwidth;
identifying a placement scheme for the fractional RBs and the integer number of RBs within the system bandwidth; and
demodulating and decoding the integer number of RBs based at least in part on the placement scheme.

17. The method of claim 16, wherein the integer number of RBs are associated with a first wireless service that uses a different numerology than a second wireless service.

18. The method of claim 16, wherein the identifying the placement scheme comprises one or more of:
identifying a one-edge placement scheme in which at least a portion of the fractional bandwidth is placed at one edge of the system bandwidth;
identifying a two-edge placement scheme in which a first portion of the fractional bandwidth is placed at a first edge of the system bandwidth and a second portion of the fractional bandwidth is placed at a second edge of the system bandwidth; or
identifying a mid-bandwidth placement scheme in which at least a portion of the fractional bandwidth is placed between two RBs of the integer number of RBs within the system bandwidth.

19. The method of claim 18, wherein the first portion of the fractional bandwidth and the second portion of the fractional bandwidth are symmetric or asymmetric.

20. The method of claim 16, wherein the placement scheme comprises a location for one or more portions of the fractional bandwidth within the system bandwidth and an RB numbering scheme for the integer number of RBs and the one or more fractional RBs transmitted within the fractional bandwidth.

21. The method of claim 20, wherein the placement scheme is determined implicitly based at least in part on the system bandwidth and a tone spacing of the integer number of RBs.

22. The method of claim 16, further comprising:
receiving signaling to indicate the placement scheme.

23. The method of claim 22, wherein the signaling is received in a system information block (SIB).

24. The method of claim 22, wherein the signaling comprises one or more bits that are mapped to a predetermined placement scheme.

25. The method of claim 16, wherein the one or more fractional RBs have a same numerology as the integer number of RBs.

26. The method of claim 16, wherein the integer number of RBs have a first numerology and the one or more fractional RBs have a second numerology that is different than the first numerology.

27. The method of claim 26, wherein the one or more fractional RBs comprise a second integer number of RBs for the second numerology.

28. The method of claim 26, wherein the one or more fractional RBs occupy a first portion of the fractional bandwidth and wherein a second portion of the fractional bandwidth is placed as a guard band between the integer number of RBs and the one or more fractional RBs.

29. An apparatus for wireless communication, comprising:
a processor;
memory in electronic communication with the processor; and
the processor and memory configured to:
identify an integer number of resource blocks (RBs) for transmission using a system bandwidth, wherein the integer number of RBs occupy less bandwidth than the system bandwidth;
identify a fractional bandwidth as a difference between a bandwidth occupied by the integer number of RBs and the system bandwidth;
identify one or more fractional RBs within at least a portion of the fractional bandwidth;
select a placement scheme for placing the integer number of RBs and the one or more fractional RBs within the system bandwidth; and
transmit information over the integer number of RBs to a receiver using the placement scheme.

30. An apparatus for wireless communication, comprising:
a processor;
memory in electronic communication with the processor; and
the processor and memory configured to:
identify an integer number of resource blocks (RBs) for a received transmission over a system bandwidth, wherein the integer number of RBs occupy less bandwidth than the system bandwidth;
identify a fractional bandwidth of the received transmission based at least in part of a difference between a bandwidth occupied by the integer number of RBs and the system bandwidth;
identify one or more fractional RBs within at least a portion of the fractional bandwidth;
identify a placement scheme for the fractional RBs and the integer number of RBs within the system bandwidth; and
demodulate and decoding the integer number of RBs based at least in part on the placement scheme.
